(19) United States
(12) Patent Application Publication
(10) Pub. No.: US 2026/0368580 A1
(43) Pub. Date: Nov. 19, 2026

(54) QUANTUM COMPUTER AND QUBIT-MAPPING METHOD FOR QUANTUM COMPUTER

(71) Applicant: POSTECH RESEARCH AND BUSINESS DEVELOPMENT FOUNDATION, Pohang-si (KR)

(72) Inventors: Seok Hyeong KANG, Pohang-si (KR); Sung Hye PARK, Pohang-si (KR); Jae Yoon SIM, Pohang-si (KR); Min Hyuk KWEON, Pohang-si (KR)

(73) Assignee: POSTECH RESEARCH AND BUSINESS DEVELOPMENT FOUNDATION, Pohang-si (KR)

(21) Appl. No.: 18/618,898

(22) Filed: Mar. 27, 2024

(30) Foreign Application Priority Data
Nov. 13, 2023 (KR) 10-2023-0156509

(51) Int. Cl. G06N 10/20; G06N 10/40

(52) U.S. Cl. CPC G06N 10/20; G06N 10/40

(57) ABSTRACT

A quantum computer may include qubit first and second mappers connected to each other. The qubit first mapper may generate interaction graphs corresponding to at least a portion of a quantum circuit, perform mapping of a logical center of the quantum circuit to a physical center of target hardware and mapping of child nodes to the logical center by using the interaction graphs, and find an isomorphic graph corresponding to the quantum circuit on the target hardware. The qubit second mapper may sequentially execute gates in the quantum circuit based on a layout between sets of logical qubits of the quantum circuit and physical qubits of the target hardware according to the isomorphic graph. A quantum computer may use or include a quantum circuit and may use, include or be connected to physical target hardware. A fast and scalable qubit-mapping method for a quantum computer is also disclosed.

### CROSS-REFERENCE TO RELATED APPLICATIONS

This application claims the benefit of and priority to Korean Patent Application No. 10-2023-0156509, filed on Nov. 13, 2023, the entirety of which is incorporated herein by reference for all purposes.

### BACKGROUND

### 1. Technical Field

The present disclosure relates to technology for a quantum computer, and particularly to, for example, qubit-mapping technology for a quantum computer, and more particularly to, for example, a fast and scalable qubit-mapping method for noisy intermediate-scale quantum computing and a quantum computer using the same.

### 2. Related Art

Classical computers, based on binary digital logic, have been the backbone of modern computing for decades. However, as computational demands continue to increase, classical computers face limitations in handling certain types of complex problems efficiently. Quantum computing offers a promising alternative by harnessing principles of quantum mechanics to process information in fundamentally different ways than classical computers.

Quantum computing uses quantum bits (qubits), which unlike classical bits, can exist in a superposition of states, representing both 0 and 1 simultaneously. This property enables quantum computers to perform parallel computations on a massive scale, potentially solving certain problems exponentially faster than classical computers.

Various physical systems have been proposed and developed to implement qubits. Each physical system offers unique advantages and challenges, with ongoing research aimed at improving qubit coherence, control, and scalability.

Despite significant progress, practical quantum computing faces several technical hurdles, including, among others, qubit decoherence, gate error rates, and limited qubit connectivity. Addressing these challenges requires innovative approaches to qubit and quantum circuit design, such as improved qubit mapping, error correction, and quantum circuit optimization.

The description of the related art should not be assumed to be prior art merely because it is mentioned in or associated with this section. The description of the related art may include information that describes one or more aspects of the subject technology, and the description in this section does not limit the invention.

### SUMMARY

The inventors of the present disclosure have recognized the problems and disadvantages of the related art and have performed extensive research and experiments. The inventors of the present disclosure have thus invented a new quantum computer and a new qubit-mapping method that substantially obviate one or more problems due to limitations and disadvantages of the related art.

One or more aspects of the present disclosure meet the needs of the related art described above, and provide an efficient heuristic for the qubit mapping with linear time complexity.

One or more other aspects of the present disclosure provide a qubit-mapping method that uses recursive graph-isomorphic search to generate the scalable initial mapping in a short runtime.

Still one or more other aspects of the present disclosure provide a qubit-mapping method capable of applying a heuristic cost function, that uses an adaptive look-ahead window to consider a discount factor that gives more reward to the front than the backside of a quantum circuit.

Still one or more other aspects of the present disclosure provide a qubit-mapping method capable of effectively improving the quality of qubit-mapping results through a post-processing.

Still one or more other aspects of the present disclosure provide a quantum computer using the qubit-mapping method.

According to one or more example embodiments of the present disclosure, a qubit-mapping method for a quantum computer (e.g., a noisy intermediate-scale quantum computer) may comprise: generating one or more interaction graphs corresponding to at least a portion of a quantum circuit; performing mapping of a logical center of the quantum circuit to a physical center of target hardware and mapping child nodes of a subtree to the logical center by using the one of more interaction graphs; repeating the performing of the mappings (i.e., the mapping of the logical center and the mapping of the child nodes) to find (or determine) an isomorphic graph corresponding to the quantum circuit on the target hardware; and sequentially executing gates in the quantum circuit based on an initial layout between sets of logical qubits of the quantum circuit and physical qubits of the target hardware according to the isomorphic graph.

The qubit-mapping method may further comprise: finding (or determining) a SWAP gate for converting (or making) a non-executable gate into an executable gate in the quantum circuit; calculating a difference in physical distance before and after adding each of all SWAP gates that are candidates for the non-executable gate; and calculating a cost function for the candidate SWAP gates based on the difference in physical distance.

The qubit-mapping method may further comprise applying a discount factor to the cost function so that backside gates in the quantum circuit are adaptively considered in a calculation of the cost function according to a calculation of the difference in physical distance.

The qubit-mapping method may further comprise selecting one of a SWAP gate and a BRIDGE gate according to a cost of each of the candidate SWAP gates calculated through the cost function.

The qubit-mapping method may further comprise mapping the quantum circuit in a reverse direction using a second (e.g., final) layout obtained through the selecting of one of the SWAP gate and the BRIDGE gate, wherein, in the mapping of the quantum circuit in the reverse direction, the non-executable gate may be found in the reverse direction, the candidate SWAP gates, which make the non-executable gate executable, may be found, the difference in physical distance before and after adding each of the found candidate SWAP gates may be calculated, one candidate SWAP gate may be selected based on the difference in physical distance, and a modified layout in which an initial layout is modified may be output by applying the selected one candidate SWAP gate (e.g., the best SWAP gate selected).

The qubit-mapping method may further comprise updating the initial layout obtained through an initial mapping, which includes finding the isomorphic graph or an alternative subgraph, to the modified layout.

The qubit-mapping method may further comprise maintaining an initial or current layout using a BRIDGE gate without using the SWAP gate when the cost is less than a designated lower bound for the cost of the SWAP gate.

The qubit-mapping method may further comprise introducing a fitting coefficient for a discount factor to determine an edge weight between adjacent nodes of the interaction graph.

The qubit-mapping method may further comprise: performing frequency matching on an isomorphic graph by searching for all possible frequency patterns of quantum hardware in the initial mapping; and sequentially executing the gates in the quantum circuit based on a layout between the physical qubits of the target hardware and the logical qubits of the quantum circuit according to the frequency matching.

The frequency matching may include searching all possible frequency patterns for an isomorphic graph by limiting the unidirectional movement of an x-axis and a y-axis of a hardware plane of the target hardware, respectively, to a certain range.

According to one or more example embodiments of the present disclosure, a quantum computer that is, for example, a noisy intermediate-scale quantum computer may comprise: a qubit first mapper; and a qubit second mapper connected to the qubit first mapper, wherein the qubit first mapper may generate one or more interaction graphs corresponding to at least a portion of a quantum circuit; perform mapping of a logical center of the quantum circuit to a physical center of target hardware and mapping of child nodes of a subtree to the logical center by using the one or more interaction graphs; and find an isomorphic graph corresponding to the quantum circuit on the target hardware by repeating the mapping of the logical center and the mapping of the child nodes, and wherein the qubit second mapper is configured to sequentially execute gates in the quantum circuit based on a layout between sets of logical qubits of the quantum circuit and physical qubits of the target hardware according to the isomorphic graph.

The qubit second mapper may find a SWAP gate that makes (or converts) a non-executable gate into an executable gate in the quantum circuit during the sequential execution of the gates in the quantum circuit, calculate a difference in physical distance before and after adding each of all SWAP gates that are candidates for the non-executable gate, and calculate a cost function for the candidate SWAP gates based on the difference in physical distance.

The qubit second mapper may apply a discount factor to the cost function so that backside gates in the quantum circuit are adaptively considered in a process of calculating the cost function according to the calculation of the difference in physical distance.

The qubit second mapper may select one of the SWAP gate and a BRIDGE gate according to a cost of each of the candidate SWAP gates calculated through the cost function.

The quantum computer may further comprise a post-processor, wherein the post-processor may map the quantum circuit in a reverse direction using a second (e.g., final) layout obtained through a process of selecting the one of the SWAP gate and the BRIDGE gate, and in the mapping of the quantum circuit in the reverse direction, the non-executable gate may be found in the reverse direction, the candidate SWAP gates, which make the non-executable gate executable, may be found, the difference in the physical distance before and after adding each of the found candidate SWAP gates may be calculated, one candidate SWAP gate may be selected based on the difference in physical distance to output a modified layout in which an initial layout is modified.

The qubit second mapper may maintain an initial or current layout using a BRIDGE gate without using the candidate SWAP gate when the cost due to the difference in physical distance of the best SWAP gate selected is less than a predetermined lower bound.

The quantum computer may further comprise performing qubit control through frequency sharing. The qubit first mapper may search for all possible frequency patterns of quantum hardware to perform frequency matching on an isomorphic graph, and sequentially execute the gates in the quantum circuit based on a layout between sets of physical qubits of the target hardware and logical qubits of the quantum circuit according to the frequency matching.

According to one or more example embodiments of the present disclosure, a quantum computer that is, for example, a noisy intermediate-scale quantum computer simultaneously controlling some of qubit groups using frequency sharing may comprise: a qubit first mapper; and a qubit second mapper connected to the qubit first mapper, wherein the qubit first mapper may generate an interaction graph corresponding to at least a portion of a quantum circuit based on a 2-qubit gate count, introduce a fitting coefficient for a discount factor to determine an edge weight between adjacent nodes of the interaction graph, limit unidirectional movement of each of an x-axis and a y-axis of a hardware plane of the target hardware to a certain range to search for all possible frequency patterns of quantum hardware to perform frequency matching on an isomorphic graph, and wherein the qubit second mapper may sequentially execute gates in the quantum circuit based on a layout between sets of physical qubits of the target hardware and logical qubits of the quantum circuit according to the frequency matching.

The qubit second mapper may find a SWAP gate for converting (or making) a non-executable gate into an executable gate in the quantum circuit, calculate a difference in physical distance before and after adding each of all SWAP gates that are candidates for the non-executable gate, and calculate a cost function for the candidate SWAP gates based on the difference in physical distance.

The qubit second mapper may map the qubits of the quantum circuit using at least one of a SWAP gate, a BRIDGE gate, or a MOVE gate according to a cost of each of the candidate gates calculated through the cost function.

In one or more aspects, the qubit-mapping method of the present disclosure is integrated into a practical application and improves the functioning of a quantum computer, as described below and herein.

According to the present disclosure, it is possible to reduce the gate overhead and runtime during the qubit mapping. The effects of this disclosure are listed as follows.

First, with a recursive graph-isomorphic search using multiple centers, it is possible to find a scalable initial solution between logical qubits and physical qubits quickly.

Second, with a heuristic cost function that uses an adaptive look-ahead window that considers the discount factor to give more reward to the front than the backside of the circuit, it is possible to reduce the search space and runtime in the main mapping and effectively select a SWAP gate and a BRIDGE gate to be used in the quantum circuit.

Third, it is possible to provide a qubit-mapping method that has linear time complexity according to the gate size, and has the merit of minimizing the circuit depth by resolving the connectivity constraints.

Fourth, compared to exact qubit-mapping methods, it is possible to provide cost-effective results for small quantum circuits in an extremely short runtime.

In addition, according to the present disclosure, it is possible to provide the efficient qubit mapping method modifying quantum circuits to enable quantum computations in quantum computers such as NISQ with connectivity constraints. In particular, with the recursive graph-isomorphic search in the initial mapping, it is possible to perform the optimized initial mapping for small quantum circuits and output the algorithmically scalable initial mapping for large quantum circuits.

Further, according to the present disclosure, it is possible to generate an initial mapping that reduces the number of additional gates and latency together in a rapid runtime through frequency-aware graph matching in qubit-mapping of hardware that simultaneously controls some groups of qubits using the frequency sharing.

Furthermore, with an adaptive look-ahead window search in the main mapping, it is possible to obtain cost-effective results by reducing the additional gate count and resolving the connectivity constraints in a rapid runtime.

Moreover, according to the qubit-mapping method of the present disclosure, it is possible to achieve the runtime having a much shorter linear time complexity compared to the prior art. That is, compared to the latest methodology of the prior art, it is possible to reduce the additional gate count to about 23% and the runtime to about 68%. In addition, by reducing the circuit depth, it is possible to allow the output circuit to be less affected by the physical limitations of a NISQ computer.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the appended drawings. It is intended that all such features, advantages, and aspects be included within this description, be within the scope of the present disclosure, and be protected by the following claims. Nothing in this section should be taken as a limitation on those claims. Further aspects and advantages are discussed below in conjunction with embodiments of the disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the disclosure, are incorporated in and constitute a part of this disclosure, illustrate aspects and embodiments of the disclosure, and together with the description serve to explain principles and examples of the disclosure. In the drawings:

FIGS. 1A to 1D are example diagrams for describing a qubit mapping problem according to one approach;

FIGS. 2A to 2C are example diagrams of quantum gates that may be used in a qubit-mapping method according to an example embodiment of the present disclosure;

FIG. 3 is a flowchart of the qubit-mapping method according to the example embodiment of the present disclosure;

FIG. 4 is a schematic block diagram of a quantum computer equipped with a qubit-mapping device according to another example embodiment of the present disclosure;

FIG. 5 is a flowchart of a qubit-mapping method according to still another example embodiment of the present disclosure;

FIG. 6 is a flowchart for describing an example of detailed processes that may be employed in the initial mapping of the qubit-mapping method of FIG. 5;

FIG. 7A is an example diagram illustrating a data structure of an interaction-weight graph that may be employed in the qubit-mapping method of FIG. 5;

FIG. 7B is an example diagram illustrating a data structure of an interaction order graph that may be employed in the qubit-mapping method of FIG. 5;

FIG. 8 is a flowchart for describing an example of detailed processes that may be employed in the main mapping of the qubit-mapping method of FIG. 5;

FIG. 9 is an example diagram illustrating a data structure of a gate list that may be employed in the qubit-mapping method of FIG. 5;

FIGS. 10A to 10D are example diagrams for describing an operating principle of a recursive graph-isomorphic search algorithm that may be employed in the qubit-mapping method of FIG. 5;

FIGS. 11A to 11C are example diagrams for describing a cost function calculation process using an adaptive look-ahead window search algorithm of the qubit-mapping method of FIG. 5;

FIG. 12 is a flowchart for describing the initial mapping that may be employed in the qubit-mapping method according to still another example embodiment of the present disclosure;

FIGS. 13A to 13C are example diagrams for describing the initial mapping phase of FIG. 12;

FIGS. 14A to 14C are example diagrams for describing a frequency matching process for the interaction graph of FIG. 13C;

FIG. 15 is an example diagram illustrating experimental results for performance evaluation of the qubit-mapping method of FIG. 5;

FIG. 16 is an example graph showing experimental results for evaluating the performance of an additional gate count of the qubit-mapping method of FIG. 5 and an average runtime for the three currently largest benchmark circuits that may be employed in one or more methods of example embodiments of the present disclosure;

FIG. 17 is an example graph showing the results of the initial mapping according to the qubit-mapping method of FIG. 5 and a benchmark size of Comparative Example;

FIG. 18 is an example graph showing evaluation results of the main mapping of the qubit-mapping method of FIG. 5 and Comparative Example (MCPE_I);

FIG. 19 is an example graph showing post-processing results depending on the number of forward-reverse traversals that may be employed in the qubit-mapping method of FIG. 5;

FIG. 20 is an example diagram illustrating performance comparison results for the qubit-mapping method of FIG. 5 and three Comparative Examples for “exact qubit mapping”;

FIG. 21 is an example graph showing performance evaluation results in runtime and time complexity depending on the benchmark size for the qubit-mapping method of FIG. 5; and

FIG. 22 is an example graph showing performance evaluation results depending on a circuit depth and the additional gate count of the qubit-mapping method of FIG. 5.

Throughout the drawings and the detailed description, unless otherwise described, the same drawing reference numerals should be understood to refer to the same elements, features, and structures. The sizes, regions and elements, and depiction thereof may be exaggerated for clarity, illustration, and/or convenience.

### DETAILED DESCRIPTION

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the terms “and/or” and “/” include any and all combinations of one or more of the associated listed items.

In example embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

The word “exemplary” is used to mean serving as an example or illustration. Embodiments are example embodiments. Aspects are example aspects. “Embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

In one or more aspects, the terms “between” and “among” may be used interchangeably simply for convenience unless stated otherwise.

Features of various embodiments of the present disclosure may be partially or entirely coupled to or combined with each other, may be technically associated with each other, and may be variously operated, linked or driven together in various ways. Embodiments of the present disclosure may be implemented or carried out independently of each other or may be implemented or carried out together in a co-dependent or related relationship. In one or more aspects, the components of each apparatus and device according to various embodiments of the present disclosure are operatively coupled and configured.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the present disclosure will be described in greater detail with reference to the accompanying drawings. In order to facilitate general understanding in describing the present disclosure, the same components in the drawings are denoted with the same reference signs, and repeated description thereof will be omitted.

Nowadays, after the doom of Moore's Law, quantum computing has attracted substantial attention as a new computing paradigm to overcome the doom. Quantum computing performs computations by exploiting quantum phenomena such as superposition and entanglement instead of classical physics when performing computations. As a result, quantum computing can provide essential speed advantages and an enormous increase in computational capacity compared to classical computations.

Quantum algorithms use specific quantum paradigms or components that have no classical equivalents. For example, quantum algorithms that rely on the quantum Fourier transform achieve exponential speedup. In general, a quantum circuit consisting of multiple logical quantum bits (qubits) and a sequence of quantum logic gates is used to describe quantum algorithms.

To enable quantum computations, a quantum computer is required to operate the quantum logic gates step-by-step. At that time, a pair of qubits interacting in the quantum logic gate is required to be physically connected on or in the quantum hardware.

Noisy intermediate-scale quantum (NISQ) computers represent current examples of quantum computing systems with limited numbers of qubits and relatively high error rates in quantum gates. NISQ computers, which consist of tens to hundreds of qubits, are primarily used for executing intermediate-scale quantum algorithms and applications such as optimization, chemistry, and materials science, among others. Further, NISQ computers perform quantum operations with some levels of errors and noise, but their errors are not yet corrected by error correction techniques.

Notably, modern NISQ computers such as those developed with various kinds of qubit technology such as IBM, Google (superconducting), PASQAL, QuEra (neutral atom), IonQ, and Quntinuum (ion trap). It is worth noting that, except for ion trap technology, NISQ computers typically exhibit limited qubit connectivity, which poses challenges for qubit-mapping strategies.

These NISQ computers leverage quantum parallelism to perform complex computations, allowing them to solve problems much faster than classical computers within a shorter period of time.

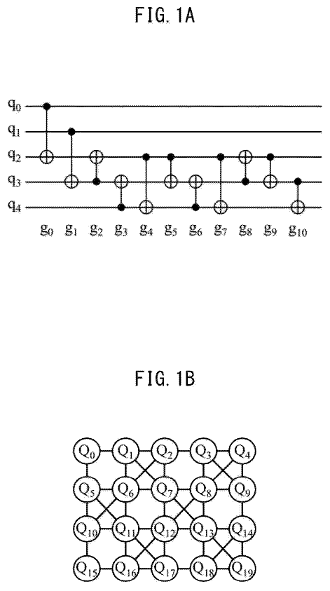

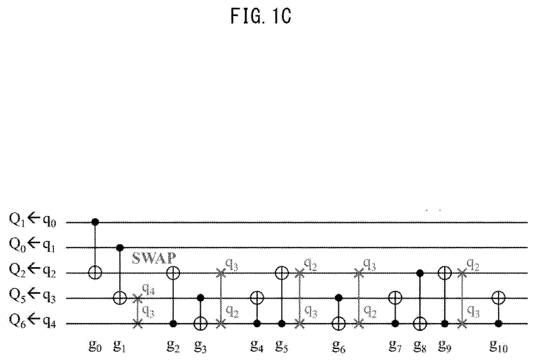

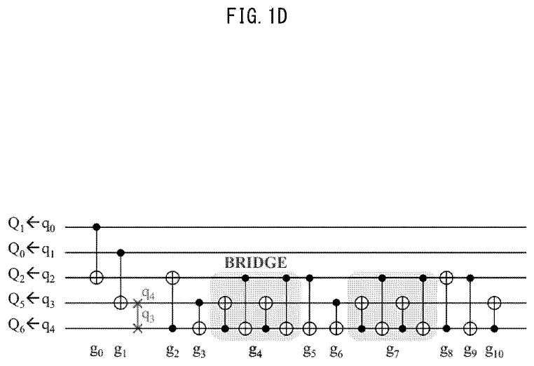

However, certain modern quantum computers (e.g., IBM Q and Google quantum computer) may be NISQ devices, which have limitations in operating quantum logic gates. This is because not every physical qubit is always connected. Therefore, to make the quantum circuit executable on target quantum hardware, quantum operations or algorithms need to be modified. This procedure may be referred to as qubit mapping, an example of which is illustrated in FIGS. 1A to 1D.

FIG. 1A illustrates an example of a real quantum circuit according to one approach. FIG. 1B illustrates a coupling graph of quantum hardware. FIG. 1C illustrates a modified circuit after qubit mapping from the quantum circuit of FIG. 1A to the coupling graph of FIG. 1B using only SWAP gates. FIG. 1D illustrates a modified circuit after qubit mapping from the quantum circuit of FIG. 1A to the coupling graph of FIG. 1B using SWAP and BRIDGE gates.

In qubit mapping, additional quantum gates, e.g., SWAP or BRIDGE gates or operations, are used to modify the quantum circuit. However, these extra quantum gates can increase the circuit depth and induce errors. The additional quantum gates have a higher error rate than do existing gates, so the computation result of the operation may eventually fail due to the accumulation of errors. The increased circuit depth may also decrease the operation accuracy due to physical limits in NISQ devices. Therefore, a qubit-mapping technology that can efficiently reduce the additional gate count (i.e., overhead) is needed.

In one or more aspects, quantum hardware may be target hardware or target quantum hardware and vice versa. In one or more aspects, quantum hardware, target hardware or target quantum hardware may include, may be, or may be a part of, for example, a physical computer, a physical processor, a physical component, or a physical device. In one or more aspects, quantum hardware, target hardware or target quantum hardware may include, may be, or may be a part of, for example, a quantum computer, a quantum processor, or components thereof. In one or examples, quantum hardware, target hardware or target quantum hardware may include superconducting circuits or components, electronic circuits or components (e.g., spintronic or ion-trapped components), and/or optical circuits or components.

In one or more aspects, a quantum computer or a quantum processor may use or may include, for example, quantum gates (e.g., gates to operate on qubits), quantum registers (e.g., registers to store quantum information or qubits), quantum circuits, quantum memories, quantum interconnects, control electronics, and/or a cryogenic system. In one or more aspects, a quantum computer or a quantum processor may include, may use, or may be connected to quantum hardware, target hardware or target quantum hardware.

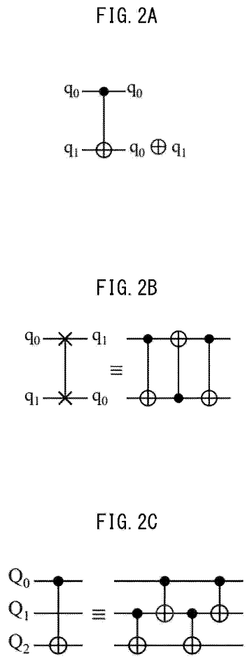

In one or more aspects, SWAP or SWAP gate may refer to or may include, for example, a quantum gate for exchanging the states of at least two qubits. In one or more aspects, BRIDGE or BRIDGE gate may refer to or may include, for example, a quantum gate for using a bridge to connect a pair of qubits within the gate that interact without being physically connected, achieved by decomposing a gate into multiple gates with directly connected qubits. FIGS. 2A to 2C are example diagrams of quantum gates that may be used in a qubit-mapping method according to an example embodiment of the present disclosure.

FIG. 2A illustrates a controlled-NOT (CNOT) gate, FIG. 2B illustrates a SWAP gate, and FIG. 2C illustrates a BRIDGE gate.

A qubit mapping problem is to map a set q of logical qubits in a quantum circuit to a set Q of physical qubits in quantum hardware. A goal of the qubit mapping problem is to minimize an additional CNOT gate count. In this process, additional quantum gates are added to the quantum circuit to resolve connectivity constraints between physical qubits.

The qubit-mapping method of the present example embodiment uses a SWAP gate and a BRIDGE gate as two types of additional quantum gates. Here, the SWAP gate exchanges states of two neighbor logical qubits on or in quantum hardware. The BRIDGE gate may convert non-adjacent neighbor CNOT gates having a physical distance of “2” into 4 adjacent CNOT gates.

Meanwhile, the qubit-mapping method of the present example embodiment uses initial mapping and main mapping to resolve the qubit-mapping problem as illustrated in FIGS. 1C and 1D, and may additionally perform post-processing. The qubit-mapping method may include a procedure of obtaining a modified quantum circuit after a qubit-mapping process from the quantum circuit to specific quantum hardware (e.g., IBM Q 20 Tokyo machine).

In the present example embodiment, any initial mapping (qᵢ [symbol] Qⱼ) between the logical qubit and the physical qubit is used. The quantum hardware executes original quantum circuits sequentially from quantum gates g₀ to g₁₀. For example, when executing g₂, logical qubits q₂ [symbol] Q₂ and q₃ [symbol] Q₅ are not directly connected on or in the quantum hardware (see FIGS. 1C and 1D). To make the quantum gate g₂ executable, the SWAP gate may be added before g₂ (see FIG. 1C). In addition, the BRIDGE gate may be used together with the SWAP gate to further reduce gate overhead (see FIG. 1D).

Meanwhile, the exact qubit mapping refers to finding an optimal qubit mapping solution that satisfies all connectivity constraints at minimal cost. According to another approach, problem solvers such as dynamic programming are used to satisfy constraints defined by a layout, which is a connection between the logical qubit and the physical qubit, and a state between each gate. However, such approach has a problem of being slow and requiring a large number of memories. In addition, such approach is difficult to scale to more than five qubits, and therefore, has the limitation of being used only for small quantum circuits.

In addition, the heuristic qubit mapping may be introduced as a practical method to overcome the speed and scalability limitations of the exact qubit mapping. The heuristic qubit mapping obtains an initial mapping solution and then uses additional gates in the main mapping to solve the connectivity constraints.

The initial mapping of the heuristic qubit mapping according to an approach updates the initial mapping through repetition of forward-reverse mapping using reversible quantum properties. However, the initial mapping does not result in a gradual decrease in an additional gate count as the mapping is repeated. In certain cases, a technique may use graph matching between the quantum circuit and hardware. However, the technique uses only one logical center, and therefore, has limitations of poor scalability. In another case, mathematical approaches such as mixed integer programming and simulated annealing techniques may be used, but have a problem in these approaches are much slower than other qubit mappings.

In certain cases, the heuristic qubit mapping according to an approach selects the SWAP gate that maximizes the effect of successive positives (+) after calculating a cost function, but does not consider reducing a search space when calculating costs. In another approach, the BRIDGE gate is used along with the SWAP gate to resolve the connectivity constraint problem. However, optimization has not yet been proposed for selecting which of the two gates to use.

As such, the qubit-mapping method of the present example embodiment may use a method of reducing the search space when calculating the costs, and also use a method of selecting which of the two gates to use when resolving the connectivity constraint problem using the SWAP gate and the BRIDGE gate, thereby optimizing the qubit mapping.

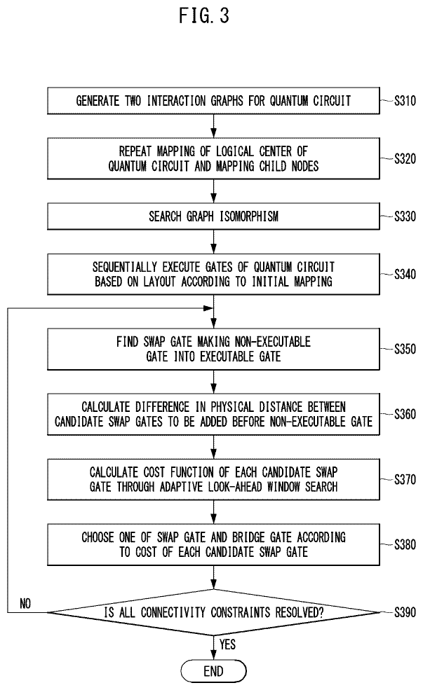

FIG. 3 is a flowchart of the qubit-mapping method according to the example embodiment of the present disclosure.

Referring to FIG. 3, the qubit-mapping method is a qubit-mapping method for a noisy intermediate-scale quantum computer, and may generate one or more interaction graphs corresponding to at least a portion of the quantum circuit (S310). The interaction graph may describe at least a portion of the quantum circuit.

In addition, the qubit-mapping method may repeat the mapping of the logical center of the quantum circuit to a physical center of target hardware and the mapping of child nodes of a subtree to the logical center by using the one or more interaction graphs (S320).

In addition, the qubit-mapping method may repeat the mapping of the logical center and the child nodes to find an isomorphic graph corresponding to the quantum circuit on the target hardware (S330). Finding the isomorphic graph is not limited to finding substantially the same graph, but may include finding similar graphs within a certain range. That is, in a broad sense, finding the isomorphic graph may include finding alternative subgraphs that are identical to at least some of the isomorphic graph. By the initial mapping of the above-described processes, it is possible to generate a layout that may be used for mapping between the logical qubit and the physical qubit.

In addition, the qubit-mapping method may sequentially execute gates in the quantum circuit based on the layout between the logical qubit and the physical qubit according to the alternative subgraph or the isomorphic graph (S340).

According to the above-described configuration, by generating a logical-physical layout through a new initial mapping employed in the qubit-mapping method of the present example embodiment and performing the main mapping based on the generated logical-physical layout, it is possible to improve the performance of the qubit mapping. In this case, the main mapping may employ the main mapping of the existing qubit-mapping method, or employ the main mapping of the present disclosure, which will be described below.

That is, in the main mapping of the present disclosure, the qubit-mapping method may find the SWAP gate that makes a non-executable gate into an executable gate in the quantum circuit (S350).

In addition, the qubit-mapping method may calculate a difference in physical distance before and after adding each of all the SWAP gates that are candidates for the non-executable gate (S360).

In addition, the qubit-mapping method may calculate the cost function for each candidate SWAP gate based on the difference in physical distance (S370).

In this case, the qubit-mapping method may apply a discount factor to the cost function so that backside gates in the quantum circuit are adaptively considered in the calculation of the cost function depending on the calculation of the difference in physical distance.

The discount factor is applied to a look-ahead window of a dynamic size rather than a static size, and may be used to add or subtract a search space of a series of sequentially executed gates when sequentially executing the remaining gates other than a head gate including a pair gate in a qubit-gate list.

In addition, the qubit-mapping method may select one of the SWAP gate and the BRIDGE gate according to the costs of each of the candidate SWAP gates calculated through the cost function (S380).

The main mapping phases S350 to S380 may be repeatedly performed until all the connectivity constraints of the quantum circuit are resolved (S390).

Since each of the above phases is described in more detail in embodiments described below, to avoid duplication of description, additional detailed descriptions of each phase will be omitted herein.

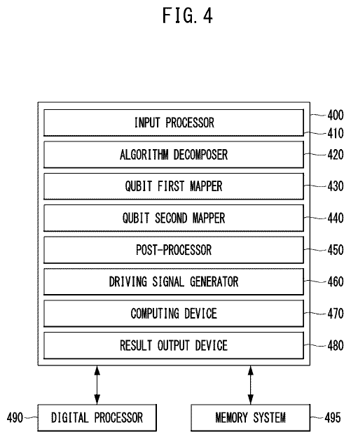

FIG. 4 is a schematic block diagram of a quantum computer equipped with a qubit-mapping device according to an example embodiment of the present disclosure.

Referring to FIG. 4, a quantum computer 400 may include a qubit first mapper 430 and a qubit second mapper 440. In addition, the quantum computer 400 may further include a post-processor 450. In addition, the quantum computer 400 may further include an input processor 410, an algorithm decomposer 420, a driving signal generator 460, a computing device 470, a result output device 480, or a combination thereof. The quantum computer 400 may be connected to one or more of a separate digital processor 490 and a memory system 495.

In the above case, programs for the quantum computer, quantum assembly codes, qubit mapping results, etc., may be stored in the memory system 495.

To describe each component in detail, first, the input processor 410 may receive at least one of the signals and data for a quantum algorithm and target hardware from the outside. The quantum algorithm is described in the form of a quantum circuit.

The algorithm decomposer 420 may decompose the quantum algorithm or the quantum circuit considering the set of native quantum gates supported by the target hardware (e.g., target quantum computer).

The qubit first mapper 430 may be configured to find the alternative subgraph so that the interaction graph matches the alternative subgraph of the quantum hardware through a recursive graph-isomorphic search to determine whether there are the connectivity constraints of the gates. In the case of an NISQ computer, one logical qubit may correspond to one physical qubit. The qubit first mapper 430 may be referred to as an initial mapper that performs initial mapping, which will be described in detail below.

The qubit second mapper 440 may be configured to calculate the cost of optimizing the gate selection while reducing the search space, and select one of the SWAP gate and the BRIDGE gate according to the cost calculation result. The qubit second mapper 440 may update an order of gates that are sequentially executed in the qubit-gate list depending on the layout of the initial mapping. The qubit second mapper 440 may be referred to as a main mapper that performs the main mapping, which will be described in detail below.

The post-processor 450 may improve mapping quality by further reducing the additional CNOT gate count.

The post-processor 450 may be configured to map the quantum circuit in a reverse direction using a final layout obtained through the process of selecting one of the SWAP gate and the BRIDGE gate. Here, mapping in the reverse direction may include a procedure of finding a non-executable gate in a reverse direction, finding the candidate SWAP gates that make the non-executable gates executable, calculating the difference in physical distance before and after adding each of the candidate SWAP gates, and selecting one of the SWAP gate or the BRIDGE gate based on the costs depending on the difference in physical distance to execute all the non-executable gates and then outputting the modified layout.

In addition, the post-processor 450 may be configured to update the initial layout obtained from the initial mapping to the modified layout. The post-processing of the post-processor 450 described above may be additionally and selectively applied to the mapping results of the main mapping.

The driving signal generator 460 may generate a driving signal to perform a quantum calculation on the modified quantum circuit obtained according to the mapping results. The driving signal generation process of the driving signal generator 460 may be applied to the mapping results in which the post-processing is omitted or performed.

The computing device 470 may perform the quantum calculation on the modified quantum circuit obtained depending on the mapping results according to the driving signal.

The result output device 480 may output the calculation result of the computing device 470 in the form of a preset signal or data.

Meanwhile, the components of the quantum computer 400 may be included in an arithmetic device, an input/output control device, and the arithmetic device and the input/output control device in a general quantum computer structure composed of software. For example, the input processor 410 and the result output device 480 may constitute at least a portion of the input/output control device, and the remaining components may constitute at least a portion of the arithmetic device.

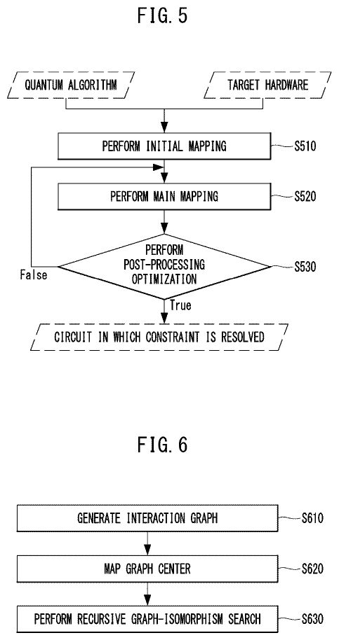

FIG. 5 is a flowchart of a qubit-mapping method according to still another example embodiment of the present disclosure.

Referring to FIG. 5, the qubit-mapping method includes an initial mapping (S510) that determines whether there are connectivity constraints affecting an additional gate count for efficient qubit mapping having excellent scalability and fast runtime, and a main mapping (S520) that optimizes the gate selection by calculating costs while reducing the search space. The initial mapping and the main mapping may be referred to as the initial mapping phase and the main mapping phase, respectively.

In addition, the qubit-mapping method may be configured to further perform the post-processing (S530) after performing the main mapping (S520). In this case, the initial mapping, the main mapping, and the post-processing may proceed sequentially. The qubit-mapping method may be executed by the quantum computer or the qubit-mapping device corresponding to the quantum computer.

Specifically, the qubit-mapping device may include some functional units of an arithmetic device for operating multiple quantum gates, such as the quantum computer, the quantum computing system, and the quantum hardware, to perform the qubit-mapping method, or a component that performs the functions of the arithmetic device. Hereinafter, the form in which the qubit-mapping device is included in a quantum computing system having a single quantum computer will be described as a base, but the present disclosure is not limited thereto and may be of course implemented as an independent quantum computing device in the quantum computing system, etc., including multiple or parallel quantum computers.

The quantum computing system including the qubit-mapping device may receive information or data on the quantum algorithm and target hardware through a logical layer or a qubit register, and process the information or data through a series of qubit processing processes such as algorithm decomposition, qubit mapping, driving signal generation, and calculation. In this case, the qubit mapping may include the initial mapping (S510) and the main mapping (S520).

The initial mapping (S510) may include a process of generating an optimal layout that minimizes connectivity constraint violations to satisfy a target hardware topology based on the quantum algorithm, including the quantum circuits, and the target hardware.

The main mapping (S520) may include a process of optimizing the gate selection to minimize the search space through an adaptive look-ahead window search (ALWS).

The initial mapping (S510) and the main mapping (S520) may be performed to minimize the additional CNOT gate count. Accordingly, the quantum computing system may output the quantum circuit in which the connectivity constraints are resolved by minimizing the additional CNOT gate count through a compiler (not illustrated).

In one or more examples, the qubit first mapper 430 may perform the operations of S510, the qubit second mapper 440 may perform the operations of S520, and the post-processor 450 may perform the operations of S530. In one or more examples, a qubit-mapping device may include or may be the quantum computer 400.

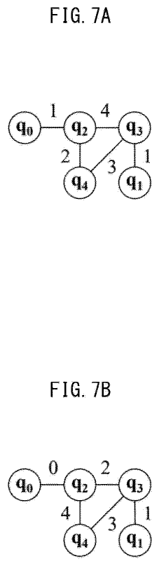

FIG. 6 is a flowchart for describing an example of detailed processes that may be employed in the initial mapping of the qubit-mapping method of FIG. 5. FIG. 7A is an example diagram illustrating a data structure of an interaction-weight graph that may be employed in the qubit-mapping method of FIG. 5. FIG. 7B is an example diagram illustrating a data structure of an interaction order graph that may be employed in the qubit-mapping method of FIG. 5.

Referring to FIG. 6, the initial mapping may find an isomorphic graph on the quantum hardware based on the interaction graph for the quantum circuit. That is, the object of the initial mapping is to find effective connections between the logical qubit and the physical qubit and minimize the connectivity constraint violations.

To the end, the initial mapping may include a process of generating the interaction graphs from the quantum circuit (S610). In addition, the initial mapping may include a process (S620) of mapping a center of the interaction graph. In particular, the initial mapping may achieve high scalability using multiple logical centers.

In addition, the initial mapping may include expanding from each logical center to child nodes in a subtree. The graph-matching processes between the logical center and the child nodes described above may be repeated. In this way, the isomorphic graph corresponding to the quantum circuit on or in the target hardware may be searched and obtained through the recursive graph-isomorphic search (S630).

Describing in more detail, the qubit-mapping device may generate one or more interaction graphs from the quantum circuit. The interaction graphs may include the interaction-weight graph and the interaction-order graph.

The interaction-weight graph may be expressed as illustrated in FIG. 7A, and the interaction-order graph may be expressed as illustrated in FIG. 7B. Each node in the interaction-weight graph and the interaction-order graph represents logical qubits q₀, q₁, q₂, q₃, and q₄. The interaction between two nodes in each graph may be expressed as an edge. In FIGS. 7A and 7B, the edge weights of each edge between two nodes are illustrated as a number.

In the interaction-weight graph, the edge weight represents the CNOT gate count in the quantum circuit, and in the interaction-order graph, the edge weight represents an index of the first CNOT gate viewed in the circuit. By using the interaction-weight graph and the interaction-order graph, it is possible to determine a graph matching order.

In the above-described initial mapping, the qubit-mapping device may use search methods such as a depth-first-search (DFS) which performs a search from a starting node all the way down to child nodes of the starting node, and a breath-first-search (BFS) that performs a search in units from the starting node to sibling nodes of the starting node or units of levels. The DFS method is a method of arranging all nodes of the quantum circuit by popping a starting node, first pushing the popped starting node in a stack, when popping each node while performing a search, pushing child nodes of the popped node in the stack, pushing all the nodes into the stack, and then popping the remaining nodes on the stack so as to generate an interaction graph of the quantum circuit based on the arrangement.

The BFS method is a method of starting from a start node, enqueuing child nodes of the start node, dequeuing the child nodes, and then enqueuing child nodes of the child node again, and may be performed by visiting all nodes to output the results by repeating the above process until there are no more nodes left in the queue. The enqueue may refer to adding the corresponding node to a queue that is a waiting line, and the dequeue may refer to releasing the corresponding node from the queue.

In addition, the initial mapping described above may further include a process of matching the interaction graph to the quantum hardware. The process of matching the interaction graph on the quantum hardware may be referred to as a recursive graph-isomorphic search (see S630 in FIG. 6).

Meanwhile, in graph matching, it is not easy to find a graph that exactly matches the interaction graph on the quantum hardware. This is because the maximum degree of the quantum hardware, that is, a coupling graph, in which the interaction graph is matched is limited. Therefore, the present example embodiment may include a process of finding an alternative subgraph in which the interaction graph matches the coupling graph of the quantum hardware through the recursive graph-isomorphic search.

For example, the qubit-mapping device may perform the recursive graph-isomorphic search by being scaled to multiple logical centers and child nodes located in their subtrees to increase scalability when finding the matching alternative subgraph. That is, the process of mapping nodes closest to each logical center to child nodes may be repeated.

The qubit-mapping device may use the interaction-weight graph to determine the order of the logical center mapping. In this way, the qubit-mapping device may consider qubits in descending order of a CNOT count.

The qubit-mapping device may perform the mapping by performing the mapping of the logical center through the interaction-weight graph and then expanding the child nodes in the subtree of the logical center using the interaction-order graph. In this way, the qubit-mapping device may maximize the 2-qubit gate connectivity for each logical center in the quantum circuit.

In other words, the qubit-mapping device may repeatedly perform the matching of the center nodes and child nodes by the interaction-weight graph and the interaction-order graph described above until all the graph matching is completed. The result of repeatedly matching the one or more interaction graphs until all graph matchings are completed may be used as a solution for the initial mapping. That is, the initial mapping solution may be an optimal layout having minimal connectivity constraint violations.

According to the configuration, every qubit interaction in the quantum gates may be connected on the quantum hardware to minimize the gate overhead.

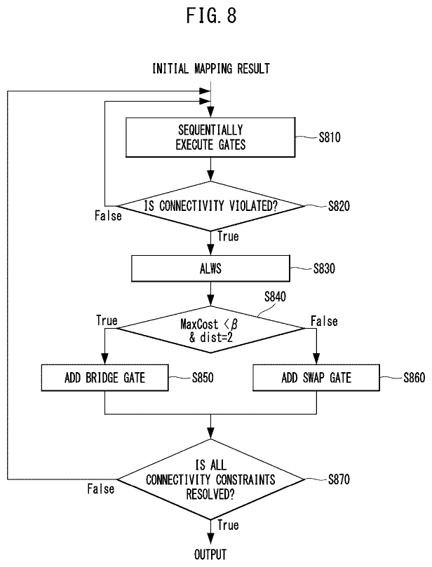

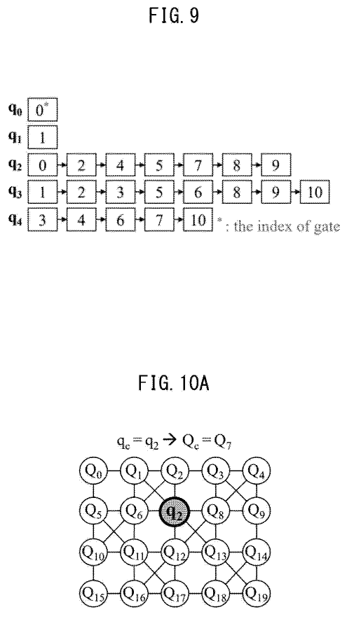

FIG. 8 is a flowchart for describing an example of detailed processes that may be employed in the main mapping of the qubit-mapping method of FIG. 5. FIG. 9 is an example diagram illustrating a data structure of the gate list that may be employed in the qubit-mapping method of FIG. 5.

Referring to FIG. 8, the main mapping first sequentially executes the gates in the quantum circuit according to the qubit-gate list (see FIG. 9) (S810).

As illustrated in FIG. 9, in the qubit-gate list, some gates g₀, g₁, and g₃ corresponding to the logical qubits q₀, q₁, q₂, q₃, and q₄ in the quantum circuit may form a head gate. The head gate may include a first logical gate g₀ which is a pair gate that operates on some pairs of logical qubits q₀ and q₂, and a second logical gate g₁ which is another pair gate that operates on some other pairs of logical qubits q₁ and q₃.

Referring back to FIG. 8, since the physical distance between the two qubits of the CNOT gate varies depending on the layout given through the initial mapping, it may be determined whether the connectivity violation is present in each gate execution order (S820).

When it is confirmed that the connectivity violation is present in any gate, the SWAP gates for which the connectivity violation is resolved when the SWAP gate is added before the gate in which the connectivity violation is present may be defined as the candidate SWAP gates. The SWAP gate may be used to exchange the state of the logical qubit pair using three CNOT gates (see FIGS. 2A and 2B).

That is, when the qubit-mapping device sequentially executes the gates according to the initial mapping result, it may exchange locations of two adjacent qubits by inserting the SWAP gate before the non-executable gates and may change the non-executable gates to the executable gates, thereby resolving the connectivity problem.

The gate list is used to determine the execution order of the gates in the main mapping, and generates the connected list set of the quantum gates for each qubit. As illustrated in FIG. 9, when the quantum circuit includes the first qubit q₀, the second qubit q₁, the third qubit q₂, the fourth qubit q₃, and the fifth qubit q₄, and the fifth qubit q₄, a connected list set of the first qubit q₀ may include an index 0 of the gate at a predetermined time stage, and a connected list set of the second qubit q₁ may include an index 1 of the gate at the same time stage as the first qubit q₀.

In addition, the connected list set of the third qubit q₂ may include indices 0, 2, 4, 5, 7, 8, and 9 of the gate at each time stage of the qubit mapping, the connected list set of the fourth qubit q₃ may include indices 1, 2, 3, 5, 6, 8, 9, and 10 of the gate at each time stage of the qubit mapping, and the connected list set of the fifth qubit q₄ may include indices 3, 4, 6, 7, and 10 of the gate at each time stage of the qubit mapping. The gate list has n connected lists corresponding to the logical qubit count, and the connected list set for each qubit represents a sequential relationship between gates related to the corresponding qubit.

Meanwhile, the qubit-mapping device may add three CNOT gates to the quantum circuit to update the logical-physical layout using the SWAP gate. However, the updated layout to which the three CNOT gates are added may affect the connectivity constraints of the rest of the circuit. Therefore, the qubit-mapping device may use the ALWS (S830) to be described below to minimize the additional gate count for the entire quantum circuit.

The qubit-mapping device may further include selecting one of the SWAP gate and the BRIDGE gate (S840). In this phase, the heuristic cost is calculated to select the SWAP gate. In this case, the qubit-mapping device may calculate the costs of each SWAP gate by calculating the difference in physical distance before and after adding the candidate SWAP gate (refer to S860).

When the cost calculation result is +1, the qubit-mapping device may determine that the corresponding SWAP gate is satisfying the connectivity by reducing the physical distance by 1. A single non-executable gate may be used for the cost calculation.

In addition, in the cost calculation, the qubit-mapping device may apply the discount factor to adaptively consider the backside gates from the candidate SWAP gates corresponding to the difference in physical distance on or in the quantum hardware. The discount factor may be a stochastic discount factor and may have a value greater than 0 and less than or equal to 1.

When using the ALWS to which the discount factor is applied, the costs of each SWAP gate may be expressed exponentially in the relationship between the cost and time. As such, the qubit-mapping device may provide more compensation for resolving the connectivity problems at the front gates than at the backside gates. This may ultimately contribute to reducing the size of the search space. In the cost function for the cost calculation, the size of the look-ahead window may affect the selected SWAP gate.

On the other hand, calculating the distance difference for only one gate on the quantum hardware may not be enough to resolve the connectivity violations. This is because the updated logical-physical layout affects the connectivity constraints for the backside gates. Therefore, the qubit-mapping device may calculate the heuristic costs of each candidate SWAP gate using the ALWS for the remaining gates in the quantum circuit to minimize the gate overhead of the quantum circuit.

In addition, the qubit-mapping device may additionally use the BRIDGE gates to more reliably resolve the connectivity violation problem (S850). The BRIDGE gate may be converted into multiple CNOT gates, where one CNOT gate having a physical distance of 2 is decomposed into four CNOT gates having the nearest distance, that is, a distance of 1.

In this way, one of the SWAP gate and the BRIDGE gate may be selected using the cost function and used to minimize the total number of gates without changing the logical-physical layout.

And then, it may be determined whether all connectivity constraints are resolved (S870). If all connectivity constraints are not resolved, the main mapping phase is returned to the phase for executing sequentially the gates.

Algorithm 1 below is an example of the recursive graph-isomorphic search algorithm that may be employed in the initial mapping of the qubit-mapping method.

[Algorithm 1]
Algorithm 1: Recursive graph-isomorphism search

| | |
|---|---|
| inputs | :Interaction-weight graph G_{w}, Interaction-order graph Gₒ, |
| | Coupling graph G_{c} and distance table dist[ ][ ] |
| output | :An Initial mapping layout[ ] ; |

| | |
|---|---|
| 1 | Initialize layout[ ]= −1 ; |
| 2 | /* layout[qᵢ] = −1, logical qubit qᵢ is not mapped on any physical |
| | qubit */ |
| 3 | Q_{c} ← CalGraphCenter(G_{c}) ; |
| 4 | q_{c} ← CalGraphCenter(G_{w}) ; |
| 5 | layout[q_{c}] ← UpdateLayout(Q_{c}) ; |
| 6 | q_{c}Queue[ ] ← BfsQueueGen(G_{w}, q_{c}) ; |
| 7 | while !q_{c}Queue[ ].empty( ) do |
| 8 | \| qᵢ ← q_{c}Queue.front( ) ; |
| 9 | \| Qᵢ ← MakeCandidateLocation(qᵢ, G_{c}) ; |
| 10 | \| if layout[qᵢ] = −1 then |
| 11 | \| \| layout[qᵢ] ← UpdateLayout(Qᵢ) ; |
| 12 | \| end |
| 13 | \| SubTree(qᵢ) ← MakeSubtree(qᵢ, Gₒ) ; |
| 14 | \| N(qᵢ) ← GetChildNodes(SubTree(qᵢ)) ; |
| 15 | \| N(Qᵢ) ← GetDistanceOnes(Qᵢ, G_{c}) ; |
| 16 | \| layout[N(qᵢ)] ← UpdateLayouts(N(Qᵢ)) ; |
| 17 | \| q_{c}Queue.pop( ) ; |
| 18 | end |
| 19 | return layout[ ] |

As illustrated in algorithm 1, the recursive graph-isomorphic search (RGIS) algorithm searches for the isomorphic graph between the quantum circuit and the quantum hardware in the initial mapping to reduce the gate count used in the qubit mapping. This is because the interactions between all the qubits of the logical gate may be connected on the quantum hardware. However, since each node in the coupling graph representing quantum hardware has a limited maximum degree, it is difficult to determine the exact graph matching. Therefore, the qubit-mapping device of the present example embodiment may be configured to use the recursive graph-isomorphic search method in the initial mapping.

As such, the goal of algorithm 1 for the recursive graph-isomorphic search method is to find the isomorphic graph or the alternative subgraph that minimizes the gate overhead of the quantum circuit.

In addition, referring to algorithm 1, in order to perform the initial mapping using the RGIS algorithm, the qubit-mapping device may be configured to receive an interaction-weight graph G_{w}, an interaction-order graph Gₒ, a coupling graph G_{c}, and a distance table ‘dist[ ][ ]’ and output the initial mapping layout.

Describing in more detail, the qubit-mapping device may first initialize a layout ‘layout[ ]’ to −1, as represented in lines 1 to 2, in the initial mapping using the RGIS algorithm. Initializing the layout to −1 indicates that the logical qubit is not mapped to any physical qubit. The layout may be implemented with the quantum register or the quantum hardware that stores the mapping results from the initial mapping in real time.

Next, the qubit-mapping device may calculate the physical graph center Q_{c} having a minimum topological distance for all the nodes of the coupling graph of the quantum hardware. When calculating a logical graph center q_{c}, the interaction-weight graph G_{w} considering qubits in descending order of the CNOT connection count may be used. The logical center may be mapped to the physical center, as represented in lines 3 to 5. According to the configuration, the qubit-mapping device may expand the alternative subgraph from the logical center with the highest degree of freedom.

Next, the qubit-mapping device may repeat the mapping of each logical center qᵢ and mapping of child nodes N(qᵢ) of the subtree for the logical center, as represented in lines 6 to 18. In this case, to determine the order of the qubits that will become the logical center, the BFS may be performed.

That is, the qubit-mapping device begins the repetitive process as represented in line 7, and maps a new logical center qᵢ to a physical qubit Qᵢ using the order of the center qubits derived previously as represented in lines 8 to 12.

Then, the qubit-mapping device may generate a subtree having the logical center qᵢ as a parent node, as represented in line 13. In this case, the interaction-order graph may be used to sequentially consider the connectivity constraints of the gate related to the parent node.

Finally, the qubit-mapping device may map the child nodes of the subtree to a node at a location close to the physical qubit, that is, having a distance of “1”, as represented in lines 14 to 17.

When the graph matching is completed (see line 18), the qubit-mapping device may output the layout between the logical qubit and the physical qubit, as represented in line 19. This output may be used as input to the main mapping which is the next process in the qubit mapping.

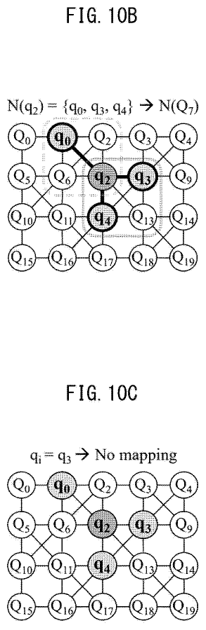

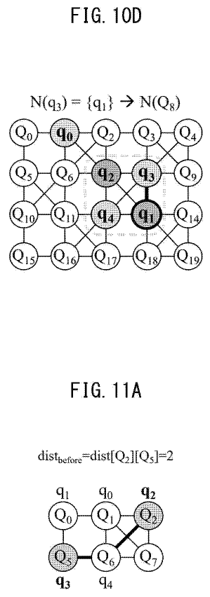

FIGS. 10A to 10D are example diagrams for describing an operating principle of the above-described recursive graph-isomorphic search algorithm.

As illustrated in FIG. 10A, the qubit-mapping device may map the logical qubit q₂, which is the first logical center q_{c}, onto a physical qubit Q₇, which is the physical center Q_{C} of the coupling graph, in a first step of the recursive graph-isomorphic search.

Next, as illustrated in FIG. 10B, the qubit-mapping device may map the logical qubits q₀, q₃, and q₄, which are the child nodes of the subtree of the logical center q₂, to the vicinity of physical location Q₇, in the second step of the recursive graph-isomorphism search.

Next, as illustrated in FIG. 10C, the qubit-mapping device may prepare to map another logical qubit q₃, which is a new logical center node qᵢ, to a center in the third step of the recursive graph-isomorphic search.

Next, as illustrated in FIG. 10D, in the fourth step of the recursive graph-isomorphism search, the qubit-mapping device may map one or more child nodes, i.e., q₁, of the subtree of the new logical center q₃ to its vicinity.

Then, the qubit-mapping device may repeat the processes described in FIGS. 10C and 10D until all the logical qubits are mapped to their respective physical locations.

The final layout obtained by the above-described recursive graph-isomorphic search result may be output as illustrated in Equation 1 below.

{q₀,q₁,q₂,q₃,q₄} [symbol] {Q₁,Q₁₃,Q₇,Q₈,Q₁₂} [Equation 1]

Using the initial mapping, the input quantum circuit may be mapped to the target hardware without using the additional gates.

Here, the time complexity of the methodology for calculating the graph center and the BFS is O(n²), and updating the layout may be expressed as O(log n). In this case, n is the logical qubit count. In addition, the complexity of generating a physical candidate may be expressed as O(m²). In this case, m is the physical qubit count. Since the initial mapping method using the recursive graph-isomorphic search in the present example embodiment is performed recursively, the overall time complexity may be expressed as Equation 2 below.

O(n²)+O(n+1)(log n+m²)=O(m²n+n²) [Equation 2]

As may be seen from Equation 2, when comparing the computational complexity of the initial mapping of the present example embodiment and the computational complexity exp(n^{1/2}) of the existing exact graph matching method, the initial mapping method using the recursive graph-isomorphic search may provide an alternative subgraph within a reasonable time complexity.

Algorithm 2 below is an example of the ALWS algorithm that may be employed in the main mapping of the qubit-mapping method in the present example embodiment.

[Algorithm 2]
Algorithm 2: Adaptive look-ahead window search

| | |
|---|---|
| inputs | :Original quantum circuit gateList[ ], Initial mapping layout[ ], |
| | Coupling graph Gc and distance table dist[ ][ ] |
| output | :Constraint-resolved circuit FinalCircuit[ ] |

| 1 | while !gateList[ ].empty( ) do | |
|---|---|---|
| 2 | \| while do | |
| 3 | \| \| headGates[ ] ← UpdateHeadGates(gateList[ ]) ; | |
| 4 | \| \| pairGates[ ] ← CheckPairs(headGates[ ]) ; | |
| 5 | \| \| execGates[ ], nonexecGates[ ] ← | |
| | \| \| CheckExecutable(pairGates[ ], layout[ ]) ; | |
| 6 | \| \| if execGates[ ].empty( ) then break | |
| 7 | \| \| foreach execGate where execGates[ ] do | |
| 8 | \| \| \| FinalCircuit[ ].push_back(execGate) ; | |
| 9 | \| \| end | |
| 10 | \| end | |
| 11 | \| candiSwap[ ] ← GetSWAPcandi(dist[ ][ ], nonexecGates[ ], G_{c}) ; | |
| 12 | \| costSwap[ ] ← CalCost(candiSwap[ ], dist[ ][ ], gateList[ ], α) ; | |
| 13 | \| /* α is a discount factor for calculating the heuristic cost (0≤ α ≤1) | */ |
| 14 | \| maxCost, bestSWAP ← FindBestSWAP(costSwap[ ]) ; | |
| 15 | \| if GetDist(nonexecGate) = 2 and maxCost ≤ β then | |
| 16 | \| \| BRIDGE ← ConvertBridge(nonexecGate) ; | |
| 17 | \| \| FinalCircuit[ ].push_back(BRIDGE) ; | |
| 18 | \| end | |
| 19 | \| /* β is minimum cost to choose the BRIDGE gate instead of SWAP gate | */ |

| | |
|---|---|
| 20 | \| else |
| 21 | \| \| FinalCircuit[ ].push_back(bestSWAP) ; |
| 22 | \| \| FinalCircuit[ ].push_back(nonexecGate) ; |
| 23 | \| \| layout[ ] ← UpdateLayout(bestSWAP) ; |
| 24 | \| end |
| 25 | end |
| 26 | return FinalCircuit[ ] |

As illustrated in algorithm 2, to perform the main mapping using the ALWS algorithm, the qubit-mapping device may be configured to receive the original quantum circuit ‘gateList[ ]’, the initial layout ‘layout[ ]’, the coupling graph G_{c}, and the distance table ‘dist[ ][ ]’, and output a circuit ‘FinalCircuit[ ]’ in which the connectivity constraints are resolved.

The qubit-mapping device may first find the optimal SWAP gate for executing the current gate in consideration of the calculated cost function. When the selected SWAP gate does not continuously produce a positive effect for the backside of the circuit, the qubit-mapping device may select the BRIDGE gate as a gate to be used. The qubit-mapping device may efficiently reduce the search size through the main mapping method using the ALWS algorithm, thereby completing the main mapping at a fast execution time regardless of the size of the quantum circuit.

Specifically, in the main mapping using the ALWS algorithm, as represented in line 3 of algorithm 2, to sequentially execute the gates in the first step of the ALWS algorithm, the gate list may be used to designate a foremost gate of each logical qubit as the head gate.

Next, as represented in line 4, when a gate is the head gate for the logical qubit pair of a CNOT gage, the qubit-mapping device may designate the corresponding gates as the pair gates, and at the same time, execute the corresponding gates now or apply the corresponding gates in any order in which the corresponding gates will operate. This is because all preceding gates of the current CNOT gate have been executed. For example, when the first head gate is {g₀, g₁, g₃}, g₀ and g₁ may be defined as the pair gates. This is because the corresponding gate becomes the head gates for each of q₀, q₂ and q₁, q₃ pairs at the same time. Thereafter, the pair gate may be divided into two cases. That is, the pair gate may be divided into an immediately executable gate ‘execGate’ and a non-executable gate ‘nonexecGate’ due to the connectivity constraints.

Next, when sorting the gate order as represented in lines 5 to 9, the qubit-mapping device may immediately add any executable gates to the final output quantum circuit, and may repeat this process until there are no more executable gates in the current layout. According to the process, the number of calculating the cost function to resolve the connectivity constraints of the gate may be reduced.

Next, the qubit-mapping device may generate the candidate SWAP gate to resolve the connectivity problem of the non-executable gate ‘nonexecGate’, as represented in line 11. And then, the qubit-mapping device may select the optimal SWAP gate based on the heuristic cost function. For each qubit of the non-executable CNOT gate, a pair of physical qubits connected with a distance of “1” may be a candidate SWAP gate.

When the effect of the candidate SWAP gate for one CNOT gate is expressed as an Equation, it is as shown in Equation 3 below.

Δdist_{g}(SWAP)=dist_{before}[Q_{c}][Qₜ]−dist_{after}[Q_{c}][Qₜ] [Equation 3]

In Equation 3, Q_{c} and Qₜ represent the physical locations of the control qubit and the target qubit of the non-executable CNOT gate g, respectively. As may be seen in Equation 3, the effect of the SWAP gate may be calculated as the difference in physical distance before and after adding the SWAP gate. Therefore, having the positive (+) value may indicate that the candidate SWAP gate resolves the connectivity constraint problem of the non-executable gate by reducing the physical distance by 1.

The main mapping is to resolve all the connectivity constraints by inserting these additional gates, e.g., SWAP gates. To the end, the main mapping of the present example embodiment may be configured to perform the ALWS to calculate the heuristic cost function.

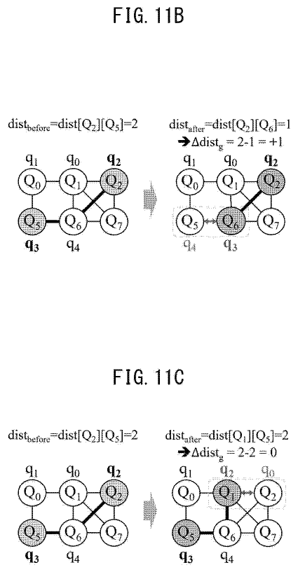

An example of the ALWS is illustrated in FIGS. 11A to 11C. FIGS. 11A to 11C are example diagrams illustrating a cost function calculation process using the ALWS that may be employed in the qubit-mapping method of the present example embodiment.

For example, as illustrated in FIG. 11A, in the main mapping, the physical distance of the qubit pair q₂ and q₃ of the CNOT gate is 2, which may cause the connectivity constraints violations. When the connectivity constraints are violated, the qubit-mapping device may apply the SWAP gate that exchanges the positions of q₃ and q₄, as illustrated in FIG. 11B. In this case, the gate effect may be calculated as +1 because the physical distance is reduced to 1. In addition, when applying the SWAP gate that changes q₀ and q₂ as illustrated in FIG. 11c, since the physical distance is maintained at 2 as before, the qubit-mapping device may calculate the gate effect as 0.

In the present example embodiment, FIGS. 11A to 11C illustrate that, when considering g₂ in the quantum circuit of FIG. 1A, the first SWAP gate is selected to resolve the connectivity constraints. The reason for the selection is that, when the first SWAP gate is used, the gate effect has a positive effect, but when the second SWAP gate is used, the physical distance between the qubit pairs of the corresponding CNOT gate is 2, which remains the same as before using the SWAP gate, and thus, there is no positive effect.

Referring back to algorithm 2, the qubit-mapping device may calculate the heuristic cost using the ALWS as represented in lines 12 to 13. The size of the gate set considered when calculating the heuristic cost function affects the performance of the selected SWAP gate. However, by calculating the heuristic cost using the ALWS, it is possible to eliminate the influence on the size of the gate set.

In this case, by applying an exponential discount factor α, more compensation for resolving the connectivity constraint problem of the non-executable gate may be given to the backside gate than to the front gate.

Finally, the heuristic cost function for one SWAP gate may be calculated as illustrated in Equation 4 below.

$$cost ( SWAP ) = {\sum }_{{g}^{′} ∈ G} {α}^{dist [ {g}^{′} ] [ SWAP ]} \cdot Δ {dist}_{{g}^{′}} ( 0 \leq α \leq 1 ) \qquad [ Equation 4 ]$$

In Equation 4, G represents the total gate set after the non-executable gate that requires the SWAP gate, and α may refer to a discount factor that is exponentially proportional to the distance between a gate g′ belonging to G and the SWAP gate.

Then, the qubit-mapping device may select a SWAP gate having the highest cost among the candidates as the best gate, as represented in line 14.

Next, the qubit-mapping device may further reduce the total number of gates by appropriately using the BRIDGE gate along with the SWAP gate, as represented in lines 15 to 24.

As described above, in the main mapping, the SWAP gates may be used to change the layout between the logical qubit and the physical qubit while solving the connectivity constraints. In this case, the changed layout affects the remaining gates at the back portion of the quantum circuit, so additional SWAP gates may be further required in certain cases. Accordingly, the qubit-mapping device may designate the lower bound of the calculated cost for the best SWAP gate as a predetermined threshold B.

When the calculated cost function is smaller than the threshold B, the SWAP gate may be considered to be of little help in resolving the connectivity problem for the remaining gates. In this case, the qubit-mapping device may be configured to use the BRIDGE gate instead of the SWAP gate without changing the layout using the SWAP gate.

When all the gates have been processed, the qubit-mapping device may terminate algorithm 2 and output the quantum circuit of the mapping result, as represented in line 26.

According to the present example embodiment, the search size may be efficiently reduced through the main mapping method using the ALWS algorithm, so the main mapping procedure may be completed within a short execution time regardless of the size of the quantum circuit.

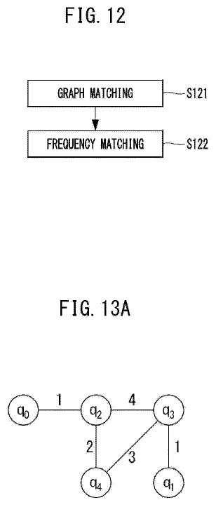

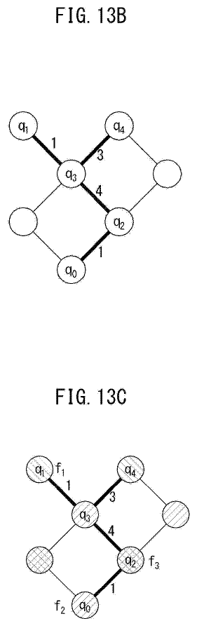

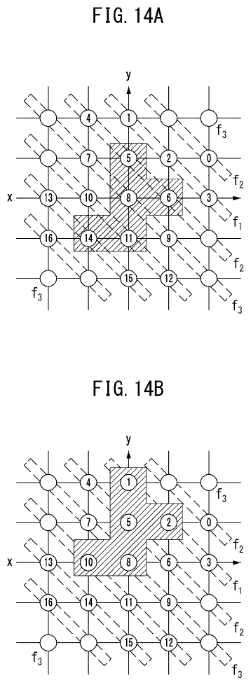

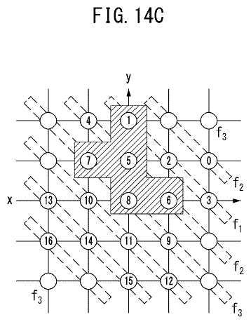

FIG. 12 is a flowchart for describing the initial mapping that may be employed in the qubit-mapping method according to still another example embodiment of the present disclosure. FIGS. 13A to 13C are example diagrams for describing the initial mapping of FIG. 12. FIGS. 14A to 14C are example diagrams for describing a frequency matching process for the isomorphic graph of FIG. 13C.

Referring to FIG. 12, the initial mapping may include processes of performing graph matching (S121) and frequency matching (S122). The initial mapping may include a frequency-aware graph matching process and may be performed by the first mapper of the quantum circuit of the quantum computer.

Algorithm 3 below exemplifies the frequency-aware graph matching-based initial mapping algorithm.

[Algorithm 3]
Algorithm 3: Frequency-aware graph matching-based initial mapping

| | |
|---|---|
| inputs | :Quantum circuit (Circ), Coupling graph (G_{c}), Frequency |
| | group (f) |
| output | :Initial mapping (π) |

| 1 | /* (1) Graph matching | */ |
|---|---|---|
| 2 | Gᵢ ← GenerateInteractionGraph(Circ, α) | |
| 3 | q_{center}, π[q_{center}] ← GenerateGraphCenter(Gᵢ, G_{c}) | |
| 4 | queue ← GenerateBfsQueue(Gᵢ, q_{center}) | |
| 5 | while queue is not empty do | |
| 6 | \| q ← queue.Front( ) | |
| 7 | \| if π is not assigned then | |
| 8 | \| \| π[q] ← MakeCandiLocation(q) | |
| 9 | \| end | |
| 10 | \| foreach qₙ where Gᵢ.Neighbor(q) do | |
| 11 | \| \| qList ← SortLargestWeight(Gᵢ.Weight(E(qₙ, Gᵢ.Neighbor(q))) | |
| 12 | \| \| π[qₙ] ← MakeCandiLocation(q, qList, MinimizeDist( )) | |
| 13 | \| end | |
| 14 | end | |
| 15 | /* (2) Frequency matching | */ |

| | |
|---|---|
| 16 | scoreₘₐₓ ← ReturnLayoutScore(π,f) |
| 17 | for moveₓ = −1 to +1 do |
| 18 | \| for move_{y} = −1 to +1 do |
| 19 | \| \| for isReflected = 0 to +1 do |
| 20 | \| \| \| π_{new} ← MakeLayout(moveₓ, move_{y}, isReflected) |
| 21 | \| \| \| score_{new} ← ReturnLayoutScore(π_{new}, f) |
| 22 | \| \| \| if score_{new} > scoreₘₐₓ then |
| 23 | \| \| \| \| scoreₘₐₓ ← score_{new} |
| 24 | \| \| \| \| π ← π_{new} |
| 25 | \| \| \| end |
| 26 | \| \| end |
| 27 | \| end |
| 28 | end |
| 29 | return π |

As illustrated in algorithm 3, in the first step of the frequency-aware graph matching-based initial mapping, the qubit-mapping device finds the initial mapping that makes the connections of qubit pairs of 2-qubit gates as close as possible (Lines 1 to 14). For example, when a specific quantum circuit appears as the interaction graph in FIG. 13A, the isomorphic graph to which the graph matching process is applied may be the same as the example illustrated in FIG. 13B.

Next, the qubit-mapping device determines the optimal frequency pattern for the isomorphic graph to reduce the latency of the final circuit (Lines 15 to 28). The process of finding the optimized frequency pattern for the isomorphic graph is illustrated in FIGS. 14A to 14C, and the initial mapping result thus obtained is illustrated in FIG. 13C.

That is, FIG. 13A illustrates the interaction graph for the quantum circuit, and FIG. 13B illustrates an isomorphic graph that is the result of matching the graph in FIG. 13A to surface code-17, a different type of quantum computer. FIG. 13C illustrates the result of finding the optimized frequency pattern for the isomorphic graph, that is, the frequency matching result.

The qubit-mapping device may use the interaction graph (hereinafter referred to as “G;”) as illustrated in FIG. 13A to find the isomorphic portion of the quantum circuit on the target hardware. The interaction graph may be composed of nodes (N) q₀, q₁, q₂, q₃, and q₄ representing each logical qubit and an edge E representing a 2-qubit gate. In FIGS. 13A to 13C, numbers on the lines connecting between adjacent nodes represent edge weights. In FIG. 13C, different shades represent different frequency patterns f₁, f₂, and f₃ of the isomorphic graph.

The qubit-mapping device may set the edge weight as shown in Equation 5 below to represent the global and local characteristics of the quantum circuit.

$${G}_{i} \cdot Weight ( E ( {q}_{c} , {q}_{t} ) ) = {\sum }_{i = 0}^{k - 1} {α}^{i} \cdot \# {CZ}_{i} ( {q}_{c} , {q}_{t} ) ( 0 \leq α \leq 1 ) \qquad [ Equation 5 ]$$

In Equation 5, q_{c} and qₜ are the control qubit and the target qubit of the 2-qubit gate g, respectively. Here, k is the number obtained by dividing the entire quantum circuit into k circuits, each containing a set number of circuit operations. #CZᵢ represents a CZ gate count in the i^{th} circuit stage, and alpha a is a constant introduced for the discount factor.

Here, the discount factor represents a fitting coefficient to reflect all the characteristics of the interaction-weight graph and the interaction-order graph described above, and #CZᵢ is multiplied by the discount factor to form the interaction edge weight by considering the CZ gate count at the front portion of the circuit to be larger than that at the back portion of the circuit.

According to the above-described configuration, in the qubit-mapping method, the violation of the connectivity constraints at the backside portion of the circuit may be minimized by considering not only the front portion of the circuit but also the entire circuit through the discount factor.

In the present example embodiment, the symbol π: q [symbol] Q is used to represent the initial mapping from the logical qubit q to the physical qubit Q. When there is no mapping for the logical qubit to the physical qubit, π may be set to −1.

Specifically, as exemplified in algorithm 3, the initial mapping first maps a center of the interaction graph to a center of the coupling graph representing hardware, as represented in lines 2 and 3 of algorithm 3, to reduce the complexity of the graph matching search.

Then, the BFS is performed to determine the graph matching order (see Line 4). The graph matching repeatedly finds the physical locations of the logical center node considering the BFS queue (see lines 6 to 9) and the child nodes connected to each logical center (see lines 10 to 13). The location candidates of the physical centers for each logical center may be generated using the locations of nodes interacting with the logical center as reference nodes. The node having the highest weight in the coupling graph may be popped. In addition, the physical location candidates for the child nodes qn may be generated using the interaction between the nodes.

In addition, the initial mapping generates a list of adjacent qubits ‘qList’ sorted by the highest edge weight for the child nodes qn. Then, only the physical nodes that may minimize the distance between the logical center node q and the qubit list ‘qList’ are left at the candidate locations. The above process is repeated until all the logical qubits that constitute the quantum circuit have unique physical locations, and obtains the finally generated isomorphic graph (see FIG. 13B). The obtained isomorphic graph is used in the frequency matching which is the next step, that is, the frequency pattern search.

In the present example embodiment, FIGS. 14A to 14C are example diagrams for describing in detail the frequency pattern search process for the isomorphic graph of FIG. 13C. Here, FIG. 14A illustrates that a specific isomorphic graph is located at 8 which is a physical center of a surface code-17 processor, FIG. 14B illustrates a case where the isomorphic graph of FIG. 14A moves up one space, and FIG. 14C illustrates a case where the isomorphic graph of FIG. 14B is symmetrically transformed about a y-axis.

The surface code-17 may be described as a rotated surface code named for the sum of its 9 data qubits and 8 syndrome qubits. It uses the smallest number of qubits to perform error correction on a surface code with parallel syndrome extraction.

The goal of the frequency pattern search, that is, the frequency matching, is to increase the probability of parallel execution between the gates when using the obtained isomorphic graph. The initial mapping in the present example embodiment may be configured to first analyze the surface code-17 processor to reduce the search space.

The surface code may be located on a Cartesian coordinate system with the physical qubit center as the origin of an axis of the Cartesian coordinate system. In the processor, each frequency pattern is repeated with a period of 4, and the number of frequency groups may be 3. Period 4 may be expressed for three frequency groups as F={f₃, f₂, f₁, f₂}.

Here, the frequency of the node in which the sum of the x-coordinate and y-coordinate is 0 is f₃. The frequency of the node at x+y=1, which moves by 1 to the right on the x-axis or moves by 1 up on the y-axis, is f₂. Next, the frequency of the node at x+y=2, which additionally reflects the movement of the x-axis or the movement of the y-axis, is f₁. Finally, the node at x+y=3 again obtains frequency f₂. Next, when the sum of x and y is 4, the frequency f₃ is obtained again. For reference, the case where the node moves by 1 to the left on the x-axis or moves by 1 down on the y-axis may correspond to x+y=−1.

In this way, the frequencies assigned to all the physical qubits may be calculated as in Equation 6 below.

i≡(x+y)mod 4⇒f(x,y)=F[i],(F={f₃,f₂,f₁,f₂}) [Equation 6]

In the initial mapping, all the possible frequency patterns are searched with only a small number of movements and symmetries based on the analysis described above.

Meanwhile, in the example of the frequency pattern search as illustrated in FIGS. 14A to 14C, when the hardware plane is wide, the entire frequency pattern may be searched only by the unidirectional movement. However, performing the frequency pattern search in that manner has limitations on the surface code-17 processor.

Therefore, in the initial mapping of the present example embodiment, in order to efficiently search for the frequency pattern, the movement on each of the x-axis and y-axis is limited to the range from −1 to 1 instead of moving in both directions. In addition, to completely search for the frequency pattern, the y-axis symmetry of the isomorphic graph is also considered. Next, the best initial mapping may be selected by predicting the degree of possible gate parallelism for all the graphs obtained by the frequency pattern search.

Meanwhile, when the hardware plane of the target hardware is larger than the surface code-17 processor by a certain size, in order to efficiently search for the frequency pattern, instead of the unidirectional movement on each of the x-axis and y-axis, it may be limited to an extended range from −3 to 3.

The degree of gate parallelism may be expressed by the corresponding score ‘Score [Gₗ]’ as shown in Equation 7.

$$Score [ {G}_{l} ] = {\sum }_{{e}_{l} ∈ {G}_{l}} {\sum }_{e ∈ {E}_{p} [ {e}_{l} ]} {G}_{i} \cdot Weight ( E ( e ↦ {q}_{s} , e ↦ {q}_{d} ) ) \qquad [ Equation 7 ]$$

In Equation 7, Gₗ and eₗ represent a candidate isomorphic graph and a set of all edges corresponding thereto, respectively, and Ep[eₗ] is a set of edges that may be executed in parallel when executing eₗ. qₛ and q_{d} represent a source qubit and a destination qubit, respectively. After all the frequency pattern searches (see FIGS. 14A to 14C) are completed, the frequency-matched graph having the highest score may be transformed (see FIG. 13C).

As described above, in the initial mapping of the qubit-mapping method of the present disclosure, it may be configured to selectively use either the recursive graph-isomorphic search or the frequency-aware graph matching. After the initial mapping, the same main mapping procedure may be performed.

However, in the above-described embodiment, it is described that one of the SWAP gate and the BRIDGE gate is ultimately selected according to the cost of the candidate SWAP gate, but the present disclosure is not limited to such a configuration, and may be configured to further use the MOVE gate. That is, the qubit-mapping method of the present disclosure may include adding the SWAP gate or the MOVE gate, or changing the non-executable gate to the BRIDGE gate in the case of the gate where the connectivity conditions are not met in the qubit mapping in the quantum circuit. According to the configuration, the connectivity problem may be effectively resolved. In one or more aspects, a MOVE gate may refer to or may include, for example, a quantum gate for moving the state(s) of one or more qubits to ancillary qubits where the quantum state is in the state.

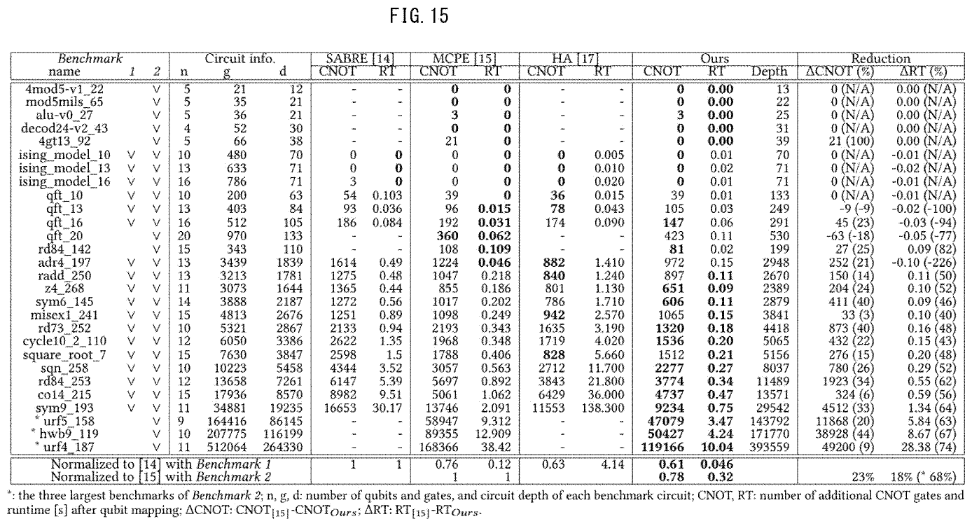

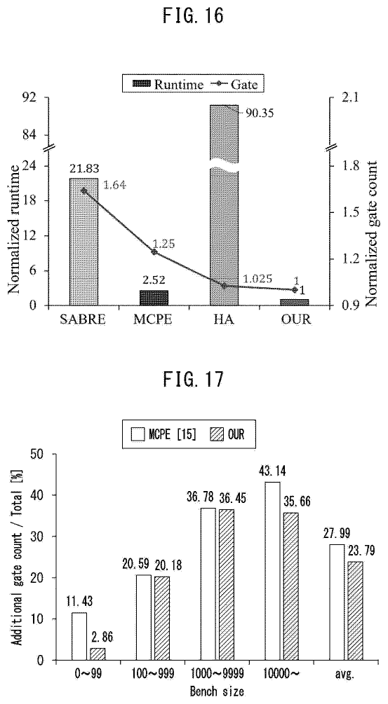

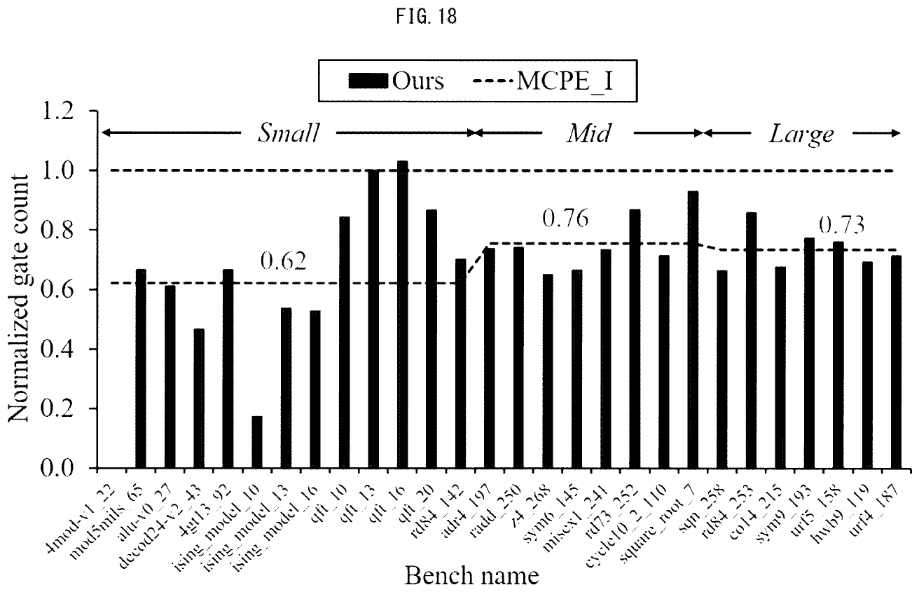

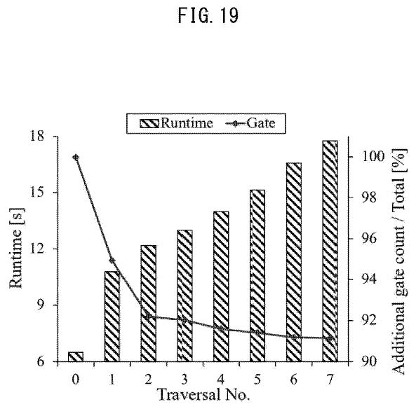

FIG. 15 is an example diagram illustrating experimental results for the performance evaluation of the qubit-mapping method of FIG. 5. FIG. 16 is an example graph showing experimental results for evaluating the performance of an additional gate count of the qubit-mapping method of FIG. 5 and an average runtime for the three currently largest benchmark circuits that may be employed in the method of the present example embodiment. FIG. 17 is an example graph showing the results of the initial mapping according to the qubit-mapping method of FIG. 5 and a benchmark size of Comparative Example. FIG. 18 is an example graph showing the evaluation results of the main mapping of the qubit-mapping method of FIG. 5 and Comparative Example (MCPE_I). FIG. 19 is an example graph showing post-processing results depending on the number of forward-reverse traversals that may be employed in the qubit-mapping method of FIG. 5.

As illustrated in FIG. 15, the qubit-mapping method of the present example embodiment (Embodiment or Our) was compared and experimented with three Comparative Examples (SABRE, MCPE, and HA) using benchmark 1. As a result of the experiment, compared to the SABRE, the qubit-mapping method of the present example embodiment (Our) reduced an additional CNOT gate count to 39% and the runtime to 95%. Compared to the HA, the qubit-mapping method of the present example embodiment reduced the additional gate count to 7% on average and the runtime to about 99%.

In the experimental analysis, the qubit-mapping method was implemented in a C++ programming language. The experimental analysis was performed using a general benchmark circuit, and the IBM Q 20 Tokyo machine was used as the target hardware for the experiment.

The indicators for the performance evaluation set the additional CNOT gate count and runtime required for the qubit mapping. In the experiment, after a preliminary experiment to set variables of algorithm 2 described above, α=0.8 and β=3 were set.

For the intuitive comparison of the results of the experiment, as illustrated in FIG. 15, normalized values of each of Comparative Examples (SABRE, MCPE, and HA) were displayed and presented as the experimental results of the qubit-mapping method of the example. That is, it may be seen that the qubit-mapping method of the present example embodiment achieves additional gate reductions of 39%, 20%, and 3% and speed improvements of 21.8 times, 2.5 times, and 90.4 times, respectively, compared to Comparative Examples.

In addition, in the qubit-mapping method of the example, as illustrated in FIG. 15, the qubit-mapping method of Comparative Example (MCPE) and the Example (OUR) were compared in benchmark 2 having a larger size. It may be seen that the qubit-mapping method reduces the additional gate count for the CNOT gate to 23% on average and reduces runtime to 68% for the three largest benchmarks, compared to the MCPE.

As a result of the above-described performance evaluation, the qubit-mapping method of the Example showed superior performance compared to Comparative Examples of the existing technologies (SABRE, MCPE, and HA). Here, it may be seen that the additional CNOT gate count is greatly reduced in ΔCNOT, which is obtained by subtracting the CNOT gate count of the Example from that of the MCPE, and its reduction percentage (%) is calculated accordingly. Similarly, it may be seen that the runtime is greatly shortened in ΔRT.

In particular, as may be seen in each of the three largest benchmarks below the table in FIG. 15, it may be seen that the qubit-mapping method of the embodiment also shows excellent performance even for the quantum circuit in which the number of qubits and the number of gates is relatively large and the circuit depth of the benchmark circuit is relatively very deep.

That is, it may be seen that the best qubit mapping results were obtained with a smaller additional CNOT gate count and more reduced runtime than Comparative Examples of the existing qubit-mapping method (see FIG. 16).

The following is evaluations for each phase, and the evaluation results of each major phase are summarized as follows.

First, in the initial mapping, comparing the initial mapping employed in the qubit-mapping method of the embodiment with the MCPE of a comparative example, for a fair comparison, under the condition that only the SWAP gate is used to resolve the connectivity constraints in the main mapping and under the condition that only one main mapping is performed without post-processing, it can be seen that the qubit-mapping method of the embodiment provides the initial mapping that is scalable to the benchmark size from a gate overhead perspective (see FIG. 17).

The qubit-mapping method of the Example may be used to find the initial mapping close to the optimal solution in a small benchmark circuit. In this way, the additional CNOT gate count may be reduced by 17% on average for the three largest benchmarks having 100,000 gates or more. This result is because the method of the Example optimizes the number and order of gate the connectivity constraints using two types of interaction graphs.

The qubit-mapping method of the Example may provide the evaluation results of the main mapping. That is, as illustrated in FIG. 18, to evaluate algorithm 2, identity mapping {qᵢ} [symbol] {Qᵢ} was used as the initial mapping. In this case, the qubit-mapping device of the Example resolved the connectivity constraint using both the SWAP gate and the BRIDGE gate, and the post-processing may be omitted.

In the present example embodiment, it may be seen that the additional gate count was reduced by 24% on average, excluding the “qft_16” benchmark. This result is because the cost function of the Example is suitable for the main mapping and also helps resolve the connectivity constraints in the back portion of the quantum circuit by optimizing the selection of the SWAP gate or the BRIDGE gate to resolve the connectivity constraints.

In addition, to evaluate the post-processing, like the methods of comparative examples (SABRE and MCPE), the method of the embodiment traversed the entire quantum circuit 15 times. That is, forward-reverse mapping was performed seven times, and forward mapping was performed once. FIG. 19 illustrates that, unlike comparative example (MCPE), the application of the post-processing to the method of the embodiment may gradually reduce the additional gate count. In addition, FIG. 19 illustrates that when performing the same number of forward-reverse traversals, the runtime for the three largest benchmark circuits is reduced by 68% on average. In this way, it may be seen that the post-processing that may be employed in the qubit-mapping method of the embodiment produces better results than the existing qubit-mapping method.

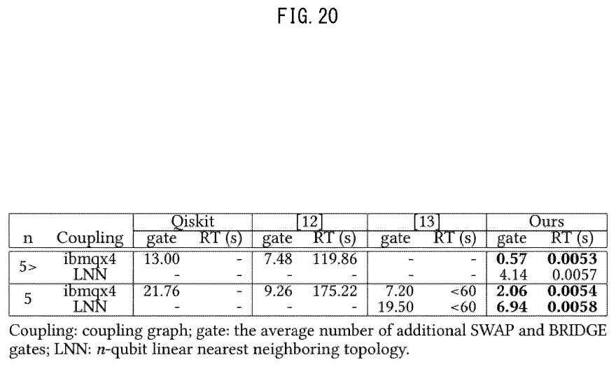

FIG. 20 is an example diagram illustrating performance comparison results for the qubit-mapping method of FIG. 5 and three comparative examples for “exact qubit mapping.”

As illustrated in FIG. 20, the results of comparative experiments on small quantum circuits for the qubit-mapping method of the embodiment (Ours) and the exact qubit-mapping methods (Qiskit, [12], [13]) of comparative examples may be seen. The is a Z3 solver-based exact algorithm and the [13] is a dynamic programming (DP)-based exact algorithm. The small quantum circuit was performed in an ibmqx4 LNN environment having 5 or less than 5 (5>) coupling graphs.

Compared to the comparative examples, the method of the embodiment illustrates that the cost-effective results were obtained within a relatively short runtime. In this way, it may be seen that, like comparative examples, the method of calculating the heuristic cost of the embodiment can be applied to hardware of limited size even if it does not focus on producing optimal results.

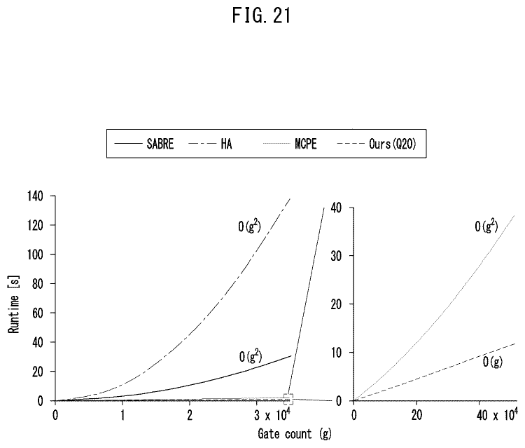

FIG. 21 is an example graph showing performance evaluation results in runtime and time complexity depending on the benchmark size for the qubit-mapping method of FIG. 5.

As illustrated in FIG. 21, it may be seen that the method of the embodiment (see Our) achieves the linear time complexity O(g) for the gate size g of the entire qubit mapping in terms of scalability. On the other hand, the methods of comparative examples (SABRE, HA, and MCPE) have polynomial time complexity O(g₂).

In FIG. 21, the bench size on the x-axis refers to the number of gates (g). Therefore, the method of the present example embodiment (OUR) may be expressed as a first-order linear equation for x. However, other comparative examples (SABRE, HA, and MCPE) are expressed as a quadratic equation for x. That is, the embodiment may represent the time complexity as O(g), but the comparative examples represent the time complexity as O(g₂).

The reason for the above-described performance difference is that the recursive graph-isomorphic search used in the method of the Example determines the initial mapping having less overhead than the methods of Comparative Example. In addition, the adaptive look-ahead window may be used to calculate the cost function to quickly select additional gates to resolve the connectivity constraints.

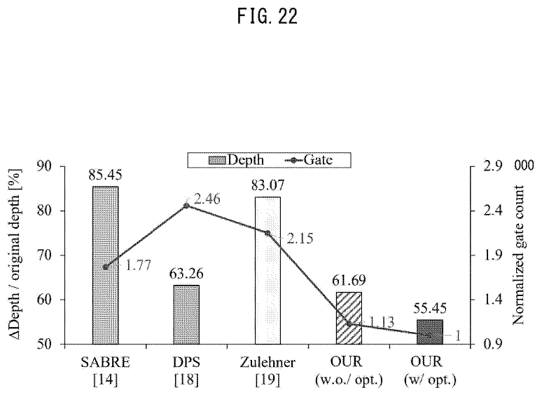

FIG. 22 is an example graph showing performance evaluation results depending on a circuit depth and the additional gate count of the qubit-mapping method of FIG. 5.

Since the NISQ computer has short coherence times, the final circuit depth affects the stability of the quantum circuit. Therefore, in the present experiment, 23 benchmark circuits (see DPS of Comparative Example) were used to compare the circuit depths of the method of the embodiment and the existing methods (SABRE, DPS, and Zulehner) of comparative examples.

As a result of the experiment, as illustrated in FIG. 22, it is illustrated that the method of the embodiment (see two OURs) maintains the circuit depth in a relatively low range not only when performing the post-processing but also when not performing the post-processing. In addition, in terms of the depth, compared to DPS, which is the qubit-mapping method in comparative examples, it may be seen that the circuit depth is reduced by 7.81% and the additional gate is reduced by 2.46 times. In this way, it may be seen that the qubit-mapping method of the Example may well reduce the circuit depth and ensure the operational stability of the quantum circuit.

The phases of the method according to the example embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus that is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some example embodiments, a programmable logic device such as a field-programmable gate array may be used to perform some or all of the functions of the methods described herein. In some example embodiments, the field-programmable gate array may be operated with a microprocessor to perform one of the methods described herein. In general, the methods are preferably performed by a certain hardware device.

The description of the disclosure provides examples and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A qubit-mapping method for a noisy intermediate-scale quantum (NISQ) computer, the qubit-mapping method comprising:
generating one or more interaction graphs corresponding to at least a portion of a quantum circuit;
performing mapping of a logical center of the quantum circuit to a physical center of target hardware and mapping child nodes of a subtree to the logical center by using the one or more interaction graphs;
repeating the performing of the mappings to find an isomorphic graph corresponding to the quantum circuit on the target hardware; and
sequentially executing gates in the quantum circuit based on a layout between sets of logical qubits of the quantum circuit and physical qubits of the target hardware according to the isomorphic graph.

2. The qubit-mapping method of claim 1, further comprising:
finding a SWAP gate for converting a non-executable CNOT gate into an executable gate in the quantum circuit;
calculating a difference in physical distance between control and target qubits for the non-executable CNOT gate before and after adding each of all SWAP gates that are candidates for the non-executable CNOT gate; and
calculating a cost function for the candidate SWAP gates based on the difference in physical distance.

3. The qubit-mapping method of claim 2, further comprising applying a discount factor to the cost function so that backside gates in the quantum circuit are adaptively considered in the calculating of the cost function according to the calculating of the difference in physical distance.

4. The qubit-mapping method of claim 2, further comprising selecting one of a SWAP gate and a BRIDGE gate according to a cost of each of the candidate SWAP gates calculated through the cost function.

5. The qubit-mapping method of claim 4, further comprising mapping the quantum circuit in a reverse direction using a second layout obtained through the selecting of one of the SWAP gate and the BRIDGE gate,
wherein in the mapping of the quantum circuit in the reverse direction:
the non-executable CNOT gate is found in the reverse direction;
the candidate SWAP gates, which make the non-executable CNOT gate executable, are found;
the difference in physical distance before and after adding each of the found candidate SWAP gates is calculated;
one candidate SWAP gate is selected based on the difference in physical distance; and
a modified layout in which an initial layout is modified is output by applying the selected one candidate SWAP gate with a highest calculated cost, wherein the highest calculated cost is determined based on the cost function for the candidate SWAP gates.

6. The qubit-mapping method of claim 5, further comprising updating the initial layout obtained through an initial mapping to the modified layout, the initial mapping including finding the isomorphic graph or an alternative subgraph preset to be used when the isomorphic graph is not found.

7. The qubit-mapping method of claim 5, further comprising maintaining an initial or current layout using a BRIDGE gate without using the selected one candidate SWAP gate when the cost of the candidate SWAP gate is less than a designated lower bound, wherein the cost is determined based on the cost function.

8. The qubit-mapping method of claim 1, further comprising introducing a fitting coefficient for a discount factor to determine an edge weight between adjacent nodes of one of the one or more interaction graphs.

9. The qubit-mapping method of claim 8, further comprising:
performing frequency matching on an isomorphic graph by searching for all possible frequency patterns of the target hardware; and
sequentially executing the gates in the quantum circuit based on a layout between sets of physical qubits of the target hardware and logical qubits of the quantum circuit according to the frequency matching.

10. The qubit-mapping method of claim 9, wherein the frequency matching may include searching all possible frequency patterns for an isomorphic graph by limiting unidirectional movement of an x-axis and a y-axis of a hardware plane of the target hardware, respectively, to a certain range.

11. A quantum computer that is a noisy intermediate-scale quantum computer, comprising:
a qubit first mapper; and
a qubit second mapper connected to the qubit first mapper,
wherein:
the qubit first mapper is configured to: generate one or more interaction graphs corresponding to at least a portion of a quantum circuit; perform mapping of a logical center of the quantum circuit to a physical center of target hardware and mapping of child nodes of a subtree to the logical center by using the one or more interaction graphs; and find an isomorphic graph corresponding to the quantum circuit on the target hardware by repeating the mapping of the logical center and the mapping of the child nodes; and
the qubit second mapper is configured to sequentially execute gates in the quantum circuit based on a layout between sets of logical qubits of the quantum circuit and physical qubits of the target hardware according to the isomorphic graph.

12. The quantum computer of claim 11, wherein the qubit second mapper is configured to:
find a SWAP gate for converting a non-executable gate into an executable gate in the quantum circuit during the sequential execution of the gates in the quantum circuit;
calculate a difference in physical distance between control and target qubits for the non-executable gate before and after adding each of all SWAP gates that are candidates for the non-executable gate; and
calculate a cost function for the candidate SWAP gates based on the difference in physical distance.

13. The quantum computer of claim 12, wherein the qubit second mapper is configured to apply a discount factor to the cost function so that backside gates in the quantum circuit are adaptively considered in a process of calculating the cost function according to the calculation of the difference in physical distance.

14. The quantum computer of claim 13, wherein the qubit second mapper is configured to select one of the SWAP gate and a BRIDGE gate according to a cost of each of the candidate SWAP gates calculated through the cost function.

15. The quantum computer of claim 14, further comprising a post-processor,
wherein the post-processor is configured to map the quantum circuit in a reverse direction using a second layout obtained through a process of selecting the one of the SWAP gate and the BRIDGE gate, and
wherein in the mapping of the quantum circuit in the reverse direction,
the non-executable gate is found in the reverse direction;
the candidate SWAP gates, which make the non-executable gate executable, are found;
the difference in physical distance before and after adding each of the found candidate SWAP gates is calculated;
one candidate SWAP gate is selected based on the difference in physical distance to output a modified layout in which an initial layout is modified.

16. The quantum computer of claim 15, wherein the qubit second mapper is configured to maintain an initial or current layout using a BRIDGE gate without using the selected one candidate SWAP gate when the cost of the candidate SWAP gate is less than a designated lower bound, wherein the cost is determined based on the cost function.

17. The quantum computer of claim 11, wherein the qubit first mapper is configured to search for all possible frequency patterns of the target hardware to perform frequency matching on an isomorphic graph, and sequentially execute the gates in the quantum circuit based on a layout between sets of physical qubits of the target hardware and logical qubits of the quantum circuit according to the frequency matching.

18. A quantum computer that is a noisy intermediate-scale quantum computer for simultaneously controlling at least some of qubit groups using frequency sharing, the quantum computer comprising:
a qubit first mapper; and
a qubit second mapper connected to the qubit first mapper,
wherein the qubit first mapper is configured to:
generate an interaction graph corresponding to at least a portion of a quantum circuit based on a 2-qubit gate count;
introduce a fitting coefficient for a discount factor to determine an edge weight between adjacent nodes of the interaction graph;
limit unidirectional movement of each of an x-axis and a y-axis of a hardware plane of target hardware to a certain range to find an isomorphic portion between the target hardware and the interaction graph; and
search for all possible frequency patterns of the target hardware to perform frequency matching on an isomorphic graph, and
wherein the qubit second mapper is configured to sequentially execute gates in the quantum circuit based on a layout between sets of physical qubits of the target hardware and logical qubits of the quantum circuit according to the frequency matching.

19. The quantum computer of claim 18, wherein the qubit second mapper is configured to:
find a SWAP gate for converting a non-executable gate into an executable gate in the quantum circuit;
calculate a difference in physical distance before and after adding each of all SWAP gates that are candidates for the non-executable gate; and
calculate a cost function for the candidate SWAP gates based on the difference in physical distance.

20. The quantum computer of claim 19, wherein the qubit second mapper is configured to execute the non-executable gate in the quantum circuit using at least one of the SWAP gate, a BRIDGE gate, a MOVE gate according to a cost of each of the candidate SWAP gates calculated through the cost function.
